(19) United States
(12) Patent Application Publication
(10) Pub. No.: US 2022/0274087 A1
(43) Pub. Date: Sep. 1, 2022

(54) MXENES FOR SELECTIVE ADSORPTION OF DESIRED CHEMICAL ANALYTES AND METHOD THEREOF

(71) Applicant: Drexel University, Philadelphia, PA (US)

(72) Inventors: Yury GOGOTSI, Warminster, PA (US); Mykola SEREDYCH, New York, NY (US); Christopher Eugene SHUCK, Philadelphia, PA (US)

(21) Appl. No.: 17/637,233

(22) PCT Filed: Aug. 26, 2020
(86) PCT No.: PCT/US2020/047970

§ 371 Date: Feb. 22, 2022

Related U.S. Application Data
(60) Provisional application No. 62/891,498, filed on Aug. 26, 2019.

(51) Int. Cl. B01J 20/02; B01D 53/58; B01D 53/68; B01D 53/72; B01J 20/28; B01J 20/34; B01J 20/30; C01B 32/921; G01N 1/40

(52) U.S. Cl. CPC B01J 20/0211; B01D 53/58; B01D 53/685; B01D 53/72; B01J 20/28016; B01J 20/3433; B01J 20/3085; B01J 20/3458; C01B 32/921; G01N 1/405; B01D 2257/2025; B01D 2253/1122

(57) ABSTRACT

Provided are methods of using MXene compositions to selectively adsorb analytes such as toxic industrial chemicals, opioids, and nerve agents. Also provided are MXene compositions configured to effect selective adsorption of analytes.

### RELATED APPLICATIONS

The present application claims priority to and the benefit of U.S. patent application No. 62/891,498, “MXenes for Selective Adsorption of Desired Chemical Analytes and Method Thereof” (filed Aug. 26, 2019), the entirety of which application is incorporated herein by reference for any and all purposes.

### TECHNICAL FIELD

The present disclosure relates to the field of selective adsorption of chemical analytes and to the field of transition metal carbide and nitride materials.

### BACKGROUND

Existing methods and materials for effecting adsorption of chemical analytes (e.g., toxins) can be slow, non-selective, and difficult to manage. Accordingly, there is a long-felt need in the art for improved methods and materials for selective adsorption of selected chemical analytes.

### SUMMARY

In meeting the described long-felt needs, the present disclosure first provides methods of adsorbing an analyte, comprising: contacting a MXene composition with the analyte, the contacting resulting in selective adsorption of the analyte to the MXene composition.

Also provided are selective adsorption systems, comprising: a MXene composition, the MXene composition being configured for placement into fluid communication with an analyte.

Further provided are analyte storage systems, comprising a MXene composition configured to selectively adsorb a first analyte (e.g., from a medium), the first analyte optionally comprising a gas.

The following is a summary of the present disclosure and technology.

### OVERVIEW

The present disclosure provides, inter alia, disclosure relates to adsorption and methods for, e.g., removing Toxic Industrial Chemicals (TIC) (ammonia, chlorine and formaldehyde), Nerve Agents and Simulants (e.g., paraoxon, dimethyl methyl phosphonate, diethyl chlorophosphonate, methyl salicylate and 2-chloroethyl ethyl sulfide, ethyl methylphosphonic acid, methylphosphonic acid, methyl salicylate), and rejection of high-abundance clutter molecules (e.g., water and hydrocarbons such as methane, toluene and octane), by the use of 2D transition metal carbides and/or nitrides (MXenes) in the form of suspensions, powders, gels, films, fabrics, composites, and fibers. One can modify the surface chemistry of MXenes with, e.g., tetramethylammonium hydroxide adsorbed acidic TIC (hydrogen sulfide, sulfur dioxide, nitrogen dioxide and hydrogen cyanide).

MXenes have broad sorption capability to, e.g., adsorbed explosives, related chemicals, nerve agents and simulates, opioids/narcotics, cholinesterase inhibitors, blood agents and toxic industrial chemicals, among other analytes.

Various surface terminations, like oxygenation (═O, —OH) and hydrogenation (—H) for preferential sorption of target chemicals (ammonia, chlorine and formaldehyde (TIC) and dimethyl methyl phosphonate, methyl salicylate and 2-chloroethyl ethyl sulfide (NAS)) and fluorination (—F) or chlorination (—Cl) for preferential rejection of high abundance clutter molecules (water and hydrocarbons) can modulate performance.

The present disclosure provides chemical control of the MXene surface terminations with subsequent control of their adsorption properties for preferential/selective sorption of target chemicals. The present composition exhibits enhanced adsorption capacity of TIC and, in some embodiments, shows high water rejection in 90% relative humidity.

Layered MXenes thus provide chemical diversity in their chemical composition and surface functionality for efficient, reversible and selective sorption of small toxic gases and/or organic molecules for use in respiratory filtration applications, MXenes/fibers as “smart textiles” for the detoxification of a nerve agents and simulants, selective sorption for gas analysis, selective storage of gases, and chemical conversion of adsorbed gases.

Advantages

Available adsorbents, such as silica gel, porous organic polymers, activated carbon, and other carbon nanostructures have limited and non-selective binding of a certain class of chemicals for filtering or detection. The main issue with this current approach is that adsorption occurs mainly in micropores (i.e. have pore size mostly less than 2 nm), which makes the process irreversible.

As one example in the case of MXenes, however, the adsorption capacity is 5.20 wt. % for ammonia, which is higher than activated carbons with well-developed microporosity. Ammonia is adsorbed either via reaction with surface groups or intercalation within interlayer spacing of MXenes. The first is responsible for strong adsorption. The layered structure and the abundance of hydroxyl groups on MXene results in its strong and selective adsorption capacity towards removal of ammonia.

Advantages of MXenes Over Porous Materials

1. Diversity of the material family. The MXene family includes a wide variety of available phases of the form (Mₙ₊₁Xₙ) where M includes Sc, Ti, V, Cr, Mn, Y, Zr, Nb, Mo, Hf, Ta, and combinations thereof; and X can be C and/or N, and n can be from 1-4. This family includes single metal MXenes Mₙ₋₁Xₙ, including, but not limited to Ti₃C₂, Ti₃CN, Ti₂C, Y₂C, Nb₂C, Nb₄C₃, Mo₂C, Cr₂C, Ta₄C₃, multiple-metal MXenes (MₐM_{b})ₙ₊₁Xₙ, including, but not limited to, e.g., Ti₂₋ₓVₓC, Ti₂₋ₓNbₓC, Nb₂₋ₓVₓC, Mo₂TiC₂, Mo₂Ti₂C₃, Mo_{1.33}Y_{0.66}C, Mo_{1.33}SC_{0.66}C, Cr₂TiC₂, and Mo₄VC₄; MXenes can also include terminations thereon, which terminations can be designated by Tₛ or T_{z}, e.g., Mo₄VC₄T_{z}, and Ti₃C₂Tₓ.

Each of these MXenes show different adsorption capacities and selectivity towards different gases.

2. Different structure with variable interlayer spacing. By performing different chemical etching treatments, including, but not limited to singular or combinations of hydrofluoric acid, hydrochloric acid, sulfuric acid, lithium chloride, lithium fluoride, sodium fluoride, followed by intercalation of various molecules, including, but not limited to singular or combinations of lithium chloride, sodium chloride, tetramethylammonium hydroxide, dimethyl sulfoxide, the interlayer spacing can be tailored for specific adsorbates.

3. Modification of the functional groups including, but not limited to simple functionalizations (e.g., ═O, —OH, —F, —Cl, —H) or complex functionalizing (grafting reactions with silanes, polymers, hydrocarbons, alcohols, and other molecules with —OH, —NH₂, and other —R groups that are reactive with MXene surfaces) for selective sorption of desired analytes.

4. MXenes can selectively release the adsorbed analytes through various treatments (thermal, electrical, chemical, mechanical) resulting in either partial or full release of gases. This leads to the MXenes being reusable after each test.

5. MXenes have been shown to be nontoxic and environmentally benign.

### BRIEF DESCRIPTION OF THE DRAWINGS

In the drawings, which are not necessarily drawn to scale, like numerals can describe similar components in different views. Like numerals having different letter suffixes can represent different instances of similar components. The drawings illustrate generally, by way of example, but not by way of limitation, various aspects discussed in the present document. In the drawings:

FIG. 1: A) Schematic of MXene synthesis by selective extraction of A element from 3 types of MAX phases. B) Colorized SEM micrograph of etched Ti₃AlC₂ on the cover of Advanced Materials issue that announced discovery of MXenes. Inset shows OH termination on the surface of a Ti₃C₂ flake. Surface terminations can be readily varied and controlled to affect properties. C) Schematic of Li-intercalated, oxygen-terminated, Ti₂C MXene on the cover of Advanced Materials, showing that the space between the flakes can accommodate a multitude of small organic and inorganic molecules.

FIG. 2: Schematic of MXene synthesis by selective extraction of A element from their ternary layered 3D Ti₃AlC₂ phase, scaling up to kg quantities: 100 g/batch synthesis with controlled temperature and feed rate.

FIG. 3: Schematic of chemical intercalations of MXenes reported to date and/or those explored in this disclosure. ML-MXene stands for as-synthesized multilayers; d-MXene stands for delaminated; c-LP is the c lattice parameter corresponding to interplanar spacings. The examples are given for Ti₃C₂Tₓ, the most extensively studied MXene to date. Similar reactions can be used for modifying ordered MXenes with various surface chemistries different from those of Ti₃C₂Tₓ, with an appropriate adjustment of process conditions and, eventually, reagents used.

FIG. 4: TA-MS analysis for vacuum annealed at 200° C. Ti₃C₂Tₓ MXene powders synthesized with 5 wt. % HF (a) and 30 wt. % HF (b).

FIG. 5: (a) Preferential rejection profile for vacuum annealed at 200° C. Ti₃C₂Tₓ MXene powders synthesized with 5 wt. % HF and 30 wt. % HF, and after exposure of MXenes to water (W) vapor for 24 hours and 72 hours; (b) Weight changes for Ti₃C₂Tₓ MXene powder synthesized with 30 wt. % HF after adsorption of Toxic Industrial Chemicals (TIC).

FIG. 6: Powder X-ray diffraction results for vacuum annealed at 200° C. Ti₃C₂Tₓ MXene powders synthesized with 30 wt. % HF, and after adsorption of Toxic Industrial Chemicals (TIC).

FIG. 7: XRD patterns for the three different etching concentrations. The MAX particles were continually stirred for 24 hours (5% HF), 18 hours (10% HF), and 3 hours (30% HF) to chemically convert the Ti₃AlC₂ into Ti₃C₂.

FIG. 8: Ti₃C₂Tₓ after etching with a) 5 wt. % HF for 24 hours, b) 10 wt. % HF for 18 hours, and c) 30 wt. % HF for 3 hours.

FIG. 9: Thermal gravimetric curves for Ti₃C₂Tₓ MXene obtained by etching Ti₃AlC₂ using HF concentrations of 5, 10 and 30 wt. % for the different particle sizes: a) Ti₃C₂Tₓ-5HF (5 wt. % HF for etching), b) Ti₃C₂Tₓ-10HF (10 wt. % HF for etching) and c) Ti₃C₂Tₓ-30HF (30 wt. % HF for etching).

FIG. 10: Thermal gravimetric curves with mass spectrometry analysis for Ti₃C₂Tₓ obtained by etching Ti₃AlC₂ using a) 5, b) 10, and c) 30 wt. % HF for 40 μm particle size.

FIG. 11: Preferential rejection profile for Ti₃C₂Tₓ with 100 μm initial particle size after Ti₃AlC₂ etching with 5 wt. % HF (a), 10 wt. % (b) and 30 wt. % (c) HF after MXene exposure to water (W) vapor for 24 and 72 hours, and d) summary of water rejection results.

FIG. 12: Amount of ammonia a) adsorbed and b) released for Ti₃C₂Tₓ for the different etching conditions, along with c) a representative mass-spectrometry profile of MXene after ammonia adsorption.

FIG. 13: Adsorption and release of methane (CH₄), toluene (C₇H₈), formaldehyde (H₂C═O), methyl salicylate (MeS), ammonia (NH₃) and chlorine (Cl₂) for Ti₃C₂Tₓ after Ti₃AlC₂ etching with 5 wt. % HF (a, d), 10 wt. % (b, e) and 30 wt. % (c, f) HF.

FIG. 14: a) XRD patterns of the MXenes before and after adsorption of NH₃, b) adsorption and release quantities of NH₃ from all three studied MXenes, and c) thermal stability of the three MXenes before and after NH₃ adsorption.

FIG. 15: a) Sorbate stabilization profile: Thermal gravimetric curves with mass spectrometry analysis for Ti₃C₂Tₓ after adsorption of formaldehyde. Ti₃C₂Tₓ was obtained by etching Ti₃AlC₂ using 5 (a), 10 (b) and 30 (c) wt. % HF with the particle size of 40 μm. The peak, centered at 100° C., is due to the release of entrapped formaldehyde molecules.

### DETAILED DESCRIPTION OF ILLUSTRATIVE EMBODIMENTS

The present disclosure can be understood more readily by reference to the following detailed description taken in connection with the accompanying figures and examples, which form a part of this disclosure. It is to be understood that this invention is not limited to the specific devices, methods, applications, conditions or parameters described and/or shown herein, and that the terminology used herein is for the purpose of describing particular embodiments by way of example only and is not intended to be limiting of the claimed invention.

Also, as used in the specification including the appended claims, the singular forms “a,” “an,” and “the” include the plural, and reference to a particular numerical value includes at least that particular value, unless the context clearly dictates otherwise. The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable, and it should be understood that steps can be performed in any order.

It is to be appreciated that certain features of the invention which are, for clarity, described herein in the context of separate embodiments, can also be provided in combination in a single embodiment. Conversely, various features of the invention that are, for brevity, described in the context of a single embodiment, can also be provided separately or in any subcombination. All documents cited herein are incorporated herein in their entireties for any and all purposes.

Further, reference to values stated in ranges include each and every value within that range. In addition, the term “comprising” should be understood as having its standard, open-ended meaning, but also as encompassing “consisting” as well. For example, a device that comprises Part A and Part B can include parts in addition to Part A and Part B, but can also be formed only from Part A and Part B.

Motivation

Two-dimensional (2D) materials have recently attracted much attention due to their electronic structures and properties, which differ from their bulk counterparts due to their lower dimensionality. Transition metal carbides and nitrides (Ti₂C, Ti₃C₂, V₂C, etc.) termed MXenes, show promise for a variety of uses. Since then we have shown these 2D solids to be both metallically conducting and hydrophilic.

Furthermore, MXenes are capable of intercalating a host of ions and organic molecules that in turn led to an outstanding performance in energy storage devices, adsorption, and photocatalytic decomposition of organic molecules in aqueous environments. Herein we propose exploration of this new, potentially quite large family of 2D materials specifically as a sorbent material, including Ti₃C₂Tₓ as representative of the MXene group.

Provided here is an examination of Toxic Industrial Chemicals (TIC) adsorption on various MXenes, beginning with Ti₃C₂Tₓ. The effects of various surface terminations, like oxygenation (═O, —OH) for preferential sorption of target chemicals and fluorination (—F) for preferential rejection of high-abundance clutter materials, are shown.

Chemical control of the MXene surface terminations with subsequent control of their adsorption properties provides for preferential sorption of target chemicals. Unfortunately, the available materials, such as silica gel, porous organic polymers, activated carbon, and other carbon nanostructures, have limited and non-selective binding of certain classes of chemicals for filtering or detection. The main issue is that adsorption occurs mainly in micropores (i.e. have pore size mostly less than 2 nm), which makes the process irreversible. Therefore, novel materials are needed to provide a larger effective surface area with specific surface chemistry for efficient, reversible, and selective sorption of small toxic gas molecules and/or organic molecules.

### BACKGROUND

Two-dimensional (2D) materials have attracted much attention in the past decade. They offer high specific surface areas, as well as electronic structures and properties that differ from their bulk counterparts due to their lower dimensionality. Graphene is the best known and the most studied 2D material, but metal oxides and hydroxides, clays, dichalcogenides, boron nitride and other materials that are one or several atoms-thin, are receiving increasing attention. 2D transition metal oxides (TMO) are promising for many applications varying from electronics to electrochemical energy storage. 2D materials can deliver combinations of properties that cannot be provided by other materials.

While transition metal carbides and nitrides possess high electrical and thermal conductivities, excellent mechanical properties, and chemical stabilities, most of them have the rock-salt (e.g., TiC) or hexagonal (e.g. V₂C) structure. In all cases, strong bonding (mixture of metallic, covalent, and ionic) is present, preventing their exfoliation, and their 2D forms were unknown before 2011.

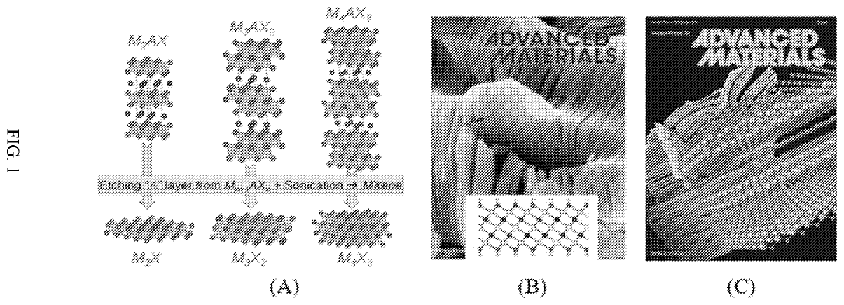

Drexel University scientists discovered and patented a new class of 2D transition metal carbides and nitrides which they labeled MXenes. The latter are so-called because they are obtained by selective etching of the MAX phases, a process shown schematically in FIG. 1A. The Mₙ₊₁AXₙ, or MAX, phases are 3D layered hexagonal compounds, wherein M is an early transition metal, A is an A-group element, such as Al, Ga, Si, etc., and X is carbon and/or nitrogen, and n is 1 to 4.

MXenes offer an unusual combination of metallic conductivity and hydrophilicity and show very attractive electrochemical and adsorption properties. To date, the following MXene compositions have been reported: Ti₃C₂, Ti₂C, (Ti_{0.5},Nb_{0.5})₂C, (V_{0.5},Cr_{0.5})₃C₂, Ti₃CN, V₂C, Nb₂C, Ta₄C₃ and Nb₄C₃. These 2D materials show promising performance as electrodes for Li-ion batteries with excellent rate handling capabilities, which were partially explained by a low Li diffusion barrier on their surfaces. Because MXenes have a large interlayer spacing and can easily expand along the c-axis, in contrast to other anodes, like Si, they do not suffer from undue intercalation strains, even at high cation loadings. In addition to Li-ion batteries, MXenes showed promise in Na and K ion batteries, and are predicted to have high capacities for multivalent ions such as Ca²⁺, Mg²⁺ and Al³⁺. Some MXenes, such as Sc₂C, are predicted to take up to 9 wt. % hydrogen.

MXenes are arguably the most important materials science discovery of the last decade—it is extremely rare when an entirely new family of materials is discovered, moreover one that shows as useful and tunable properties at such early stages of exploration as they do.

Herein is provided using this newest, and potentially largest ever family of 2D materials as efficient sorbent for chemical sampling and storage.

While MXenes have already shown great promise for applications in energy storage, exploration of their sorption properties remain uncharted scientific frontiers. Theoretical predictions of giant Seebeck coefficients, magnetism, tunable band gaps up to 1 eV, higher hydrogen sorption than graphene, higher elastic properties (Young's moduli) than those of binary MX carbides, and suitable performance as electrodes for Na⁺, Ca²⁺, Al³⁺ and Mg²⁺ batteries show the exist for these new materials. MXene surface chemistry can be used in connection with chemical sampling and storage.

MXene Background

MXenes have shown promise in many applications such as energy storage, catalysis, EMI shielding, among many others. However, MXene oxidation in aqueous colloidal suspensions when stored in water at ambient conditions remains a challenge. Herein we show that by simply capping the edges of individual MXene flakes—herein exemplified as Ti₃C₂T_{z} and V₂CT_{z}—by polyanions such as polyphosphates, polysilicates and polyborates it is possible to quite significantly reduce their propensity for oxidation even in aerated water for weeks. This breakthrough is consistent with the realization that the edges of MXene sheets were positively charged. It is thus the first example of selectively functionalizing the edges differently from the MXene sheet surfaces.

While exemplified for these two foregoing MXene compositions, the methods employed here (and resulting compositions) extend to other MXene compositions. MXene compositions are also sometimes described in terms of the phrase “MX-enes” or “MX-ene compositions.” MXenes can be described as two-dimensional transition metal carbides, nitrides, or carbonitrides comprising at least one layer having first and second surfaces, each layer described by a formula Mₙ₊₁Xₙ Tₓ and comprising:

a substantially two-dimensional array of crystal cells,

each crystal cell having an empirical formula of Mₙ₊₁Xₙ, such that each X is positioned within an octahedral array of M,

wherein M is at least one Group IIIB, IVB, VB, or VIB metal,

wherein each X is C, N, or a combination thereof;

n=1, 2, 3, or 4; and wherein

Tₓ represents surface termination groups.

These so-called MXene compositions have been described in U.S. Pat. No. 9,193,595 and Application PCT/US2015/051588, filed Sep. 23, 2015, each of which is incorporated by reference herein in its entirety at least for its teaching of these compositions, their (electrical) properties, and their methods of making. That is, any such composition described in this Patent is considered as applicable for use in the present applications and methods and within the scope of the present invention. For the sake of completeness, M can be at least one of Sc, Y, Lu, Ti, Zr, Hf, V, Nb, Ta, Cr, Mo, or W. In certain embodiments in this class, M is at least one Group IVB, Group VB, or Group VIB metal, preferably Ti, Mo, Nb, V, or Ta. Certain of these compositions include those having one or more empirical formula wherein Mₙ₊₁Xₙ comprises Sc₂C, Ti₂C, V₂C, Cr₂C, Cr₂N, Zr₂C, Nb₂C, Hf₂C, Ti₃C₂, V₃C₂, Ta₃C₂, Ti₄C₃, V₄C₃, Ta₄C₃, Sc₂N, Ti₂N, V₂N, Cr₂N, Cr₂N, Zr₂N, Nb₂N, Hf₂C, Ti₃N₂, V₃C₂, Ta₃C₂, Ti₄N₃, V₄C₃, Ta₄N₃, Mo₄VC₄ or a combination or mixture thereof. In particular embodiments, the Mₙ₊₁Xₙ structure comprises Ti₃C₂, Ti₂C, Ta₄C₃ or (V_{1/2}Cr_{1/2})₃C₃. In some embodiments, M is Ti or Ta, and n is 1, 2, 3, or 4, for example having an empirical formula Ti₃C₂ or Ti₂C. In some of these embodiments, at least one of said surfaces of each layer has surface terminations comprising hydroxide, oxide, sub-oxide, or a combination thereof. In certain preferred embodiments, the MXene composition is described by a formula Mₙ₊₁Xₙ Tₓ, where Mₙ₊₁Xₙ are Ti₂CTₓ, Mo₂TiC₂Tₓ, Ti₃C₂Tₓ, or a combination thereof, and Tₓ is as described herein. Those embodiments wherein M is Ti, and n is 1 or 2, preferably 2, are especially preferred.

In other embodiments, the articles of manufacture and methods use compositions, wherein the two-dimensional transition metal carbide, nitrides, or carbonitride comprises a composition having at least one layer having first and second surfaces, each layer comprising:

a substantially two-dimensional array of crystal cells,

each crystal cell having an empirical formula of M′₂M″ₙXₙ₊₁, such that each X is positioned within an octahedral array of M′ and M″, and where M″n are present as individual two-dimensional array of atoms intercalated (sandwiched) between a pair of two-dimensional arrays of M′ atoms,

wherein M′ and M″ are different Group IIIB, IVB, VB, or VIB metals (especially where M′ and M″ are Ti, V, Nb, Ta, Cr, Mo, or a combination thereof),

wherein each X is C, N, or a combination thereof, preferably C; and

n=1 or 2.

These compositions are described in, e.g., PCT/US2016/028354, filed Apr. 20, 2016, which is incorporated by reference herein in its entirety at least for its teaching of these compositions and their methods of making. For the sake of completeness, in some embodiments, M′ is Mo, and M″ is Nb, Ta, Ti, or V, or a combination thereof. In other embodiments, n is 2, M′ is Mo, Ti, V, or a combination thereof, and M″ is Cr, Nb, Ta, Ti, or V, or a combination thereof. In still further embodiments, the empirical formula M′₂M″ₙXₙ₊₁ comprises Mo₂TiC₂, Mo₂VC₂, Mo₂TaC₂, Mo₂NbC₂, Mo₂Ti₂C₃, Cr₂TiC₂, Cr₂VC₂, Cr₂TaC₂, Cr₂NbC₂, Ti₂NbC₂, Ti₂TaC₂, V₂TaC₂, or V₂TiC₂, preferably Mo₂TiC₂, Mo₂VC₂, Mo₂TaC₂, or Mo₂NbC₂, or their nitride or carbonitride analogs. In still other embodiments, M′₂M″ₙXₙ₊₁ comprises Mo₂Ti₂C₃, Mo₂V₂C₃, Mo₂Nb₂C₃, Mo₂Ta₂C₃, Cr₂Ti₂C₃, Cr₂V₂C₃, Cr₂Nb₂C₃, Cr₂Ta₂C₃, Nb₂Ta₂C₃, Ti₂Nb₂C₃, Ti₂Ta₂C₃, V₂Ta₂C₃, V₂Nb₂C₃, or V₂Ti₂C₃, preferably Mo₂Ti₂C₃, Mo₂V₂C₃, Mo₂Nb₂C₃, Mo₂Ta₂C₃, Ti₂Nb₂C₃, Ti₂Ta₂C₃, or V₂Ta₂C₃, or their nitride or carbonitride analogs.

A MXene composition can also comprise, e.g., a layer comprising a two-dimensional array of crystal cells, each crystal cell having an empirical formula of M₅X₄, such that each X is positioned within an array of M, wherein M is at least one Group IIIB, IVB, VB, or VIB metal or a lanthanide, wherein each X is C, N, or a combination thereof.

A MXene composition can also comprise, e.g., a substantially two-dimensional array of crystal cells, the layer having a first surface and a second surface, each crystal cell having an empirical formula of M₅X₄(Tₛ), such that each X is positioned within an array of M, wherein M is at least one Group IIIB, IVB, VB, or VIB metal or a lanthanide, wherein each X is C, N, or a combination thereof, wherein at least one of the first surface and the second surface comprises surface terminations Tₛ, the surface terminations independently comprising alkoxide, alkyl, carboxylate, halide, hydroxide, hydride, oxide, sub-oxide, nitride, sub-nitride, sulfonate, thiol, or any combination thereof.

Each of these compositions having empirical crystalline formulae Mₙ₊₁Xₙ or M′₂M″ₙXₙ₊₁ are described in terms of comprising at least one layer having first and second surfaces, each layer comprising a substantially two-dimensional array of crystal cells. In some embodiments, these compositions comprise layers of individual two-dimensional cells. In other embodiments, the compositions comprise a plurality of stacked layers. Additionally, in some embodiments, at least one of said surfaces of each layer has surface terminations (optionally designated “Tₛ” or “Tₓ”) comprising alkoxide, carboxylate, halide, hydroxide, hydride, oxide, sub-oxide, nitride, sub-nitride, sulfide, thiol, or a combination thereof. In some embodiments, at least one of said surfaces of each layer has surface terminations comprising alkoxide, fluoride, hydroxide, oxide, sub-oxide, or a combination thereof. In still other embodiments, both surfaces of each layer have said surface terminations comprising alkoxide, fluoride, hydroxide, oxide, sub-oxide, or a combination thereof. As used herein the terms “sub-oxide,” “sub-nitride,” or “sub-sulfide” is intended to connote a composition containing an amount reflecting a sub-stoichiometric or a mixed oxidation state of the M metal at the surface of oxide, nitride, or sulfide, respectively. For example, various forms of titania are known to exist as TiOₓ, where x can be less than 2. Accordingly, the surfaces of the present invention can also contain oxides, nitrides, or sulfides in similar sub-stoichiometric or mixed oxidation state amounts.

In the present disclosure, these MXenes can comprise simple individual layers, a plurality of stacked layers, or a combination thereof. Each layer can independently comprise surfaces functionalized by any of the surface coating features described herein (e.g., as in alkoxide, carboxylate, halide, hydroxide, hydride, oxide, sub-oxide, nitride, sub-nitride, sulfide, thiol, or a combination thereof) or can be also partially or completely functionalized by polymers, either on the surface of individual layers, for example, where the two-dimensional compositions are embedded within a polymer matrix, or the polymers can be intercalated between layers to form structural composites, or both.

### General Terms

In the present disclosure the singular forms “a,” “an,” and “the” include the plural reference, and reference to a particular numerical value includes at least that particular value, unless the context clearly indicates otherwise. Thus, for example, a reference to “a material” is a reference to at least one of such materials and equivalents thereof known to those skilled in the art.

When a value is expressed as an approximation by use of the descriptor “about,” it will be understood that the particular value forms another embodiment. In general, use of the term “about” indicates approximations that can vary depending on the desired properties sought to be obtained by the disclosed subject matter and is to be interpreted in the specific context in which it is used, based on its function. The person skilled in the art will be able to interpret this as a matter of routine. In some cases, the number of significant figures used for a particular value can be one non-limiting method of determining the extent of the word “about.” In other cases, the gradations used in a series of values can be used to determine the intended range available to the term “about” for each value. Where present, all ranges are inclusive and combinable. That is, references to values stated in ranges include every value within that range.

It is to be appreciated that certain features of the invention which are, for clarity, described herein in the context of separate embodiments, can also be provided in combination in a single embodiment. That is, unless obviously incompatible or specifically excluded, each individual embodiment is deemed to be combinable with any other embodiment(s) and such a combination is considered to be another embodiment. Conversely, various features of the invention that are, for brevity, described in the context of a single embodiment, can also be provided separately or in any sub-combination. Finally, while an embodiment can be described as part of a series of steps or part of a more general structure, each said step can also be considered an independent embodiment in itself, combinable with others.

The transitional terms “comprising,” “consisting essentially of” and “consisting” are intended to connote their generally in accepted meanings in the patent vernacular; that is, (i) “comprising,” which is synonymous with “including,” “containing,” or “characterized by,” is inclusive or open-ended and does not exclude additional, unrecited elements or method steps; (ii) “consisting of” excludes any element, step, or ingredient not specified in the claim; and (iii) “consisting essentially of” limits the scope of a claim to the specified materials or steps and those that do not materially affect the basic and novel characteristic(s) of the claimed invention. Embodiments described in terms of the phrase “comprising” (or its equivalents), also provide, as embodiments, those which are independently described in terms of “consisting of” and “consisting essentially of” For those composition embodiments provided in terms of “consisting essentially of,” the basic and novel characteristic(s) is the ability to provide the described effect associated with the description as described herein or as explicitly specified.

When a list is presented, unless stated otherwise, it is to be understood that each individual element of that list, and every combination of that list, is a separate embodiment. For example, a list of embodiments presented as “A, B, or C” is to be interpreted as including the embodiments, “A,” “B,” “C,” “A or B,” “A or C,” “B or C,” or “A, B, or C.”

Throughout this specification, words are to be afforded their normal meaning, as would be understood by those skilled in the relevant art. However, so as to avoid misunderstanding, the meanings of certain terms will be specifically defined or clarified.

The terms “MXenes” or “two-dimensional (2D) crystalline transition metal carbides” or two-dimensional (2D) transition metal carbides” can be used interchangeably to refer collectively to compositions described herein as comprising substantially two-dimensional crystal lattices of the general formulae Mₙ₊₁Xₙ(Tₛ), M₂A₂X(Tₛ) and M′₂M″ₙXₙ₊₁(Tₛ), where M, M′, M″, A, X, and Tₛ are defined herein. Supplementing the descriptions herein, Mₙ₊₁Xₙ(Tₛ) (including M′₂M″ₘXₘ₊₁(Tₛ) compositions) can be viewed as comprising free standing and stacked assemblies of two dimensional crystalline solids. Collectively, such compositions are referred to herein as “Mₙ₊₁Xₙ(Tₛ),” “MXene,” “MXene compositions,” or “MXene materials.” Additionally, these terms “Mₙ₊₁Xₙ(Tₛ),” “MXene,” “MXene compositions,” or “MXene materials” can also independently refer to those compositions derived by the chemical exfoliation of MAX phase materials, whether these compositions are present as free-standing 2-dimensional or stacked assemblies (as described further below). These compositions can be comprised of individual or a plurality of such layers. In some embodiments, the MXenes comprising stacked assemblies can be capable of, or have atoms, ions, or molecules, that are intercalated between at least some of the layers. In other embodiments, these atoms or ions are lithium.

The term “crystalline compositions comprising at least one layer having first and second surfaces, each layer comprising a substantially two-dimensional array of crystal cells” refers to the unique character of these materials. For purposes of visualization, the two-dimensional array of crystal cells can be viewed as an array of cells extending in an x-y plane, with the z-axis defining the thickness of the composition, without any restrictions as to the absolute orientation of that plane or axes. It is preferred that the at least one layer having first and second surfaces contain but a single two-dimensional array of crystal cells (that is, the z-dimension is defined by the dimension of approximately one crystal cell), such that the planar surfaces of said cell array defines the surface of the layer; it should be appreciated that real compositions can contain portions having more than single crystal cell thicknesses.

That is, as used herein, “a substantially two-dimensional array of crystal cells” refers to an array which preferably includes a lateral (in x-y dimension) array of crystals having a thickness of a single unit cell, such that the top and bottom surfaces of the array are available for chemical modification.

The MXene component of these compositions can be any of the compositions described in any one of U.S. patent application Ser. No. 14/094,966, International Applications PCT/US2012/043273, PCT/US2013/072733, PCT/US2015/051588, PCT/US2016/020216, or PCT/US2016/028,354. Specific such compositions are described elsewhere herein. In certain preferred embodiments, the MXenes comprise substantially two-dimensional array of crystal cells, each crystal cell having an empirical formula of Mₙ₊₁Xₙ, or M′₂M″ₙXₙ₊₁, where M, M′, M″, and X are defined elsewhere herein. Those descriptions are incorporated here. In some independent embodiments, M is Ti or Ta.

MXenes are known in the art to include nanosheet compositions comprising substantially two-dimensional array of crystal cells having the general formulae M₂X, M₃X₂, M₄X₃ and M₅X₄. The MXene compositions described herein are also sometimes described in terms of the phrase “MX-enes” or “MX-ene compositions.” MXenes have shown great promise for a variety of applications including energy storage, electromagnetic interference shielding, sensors, water purifications, and medicine.

In some embodiments, MXenes are described as two-dimensional transition metal carbides, nitrides, or carbonitrides comprising at least one layer having first and second surfaces, each layer described by a formula Mₙ₊₁Xₙ Tₓ and comprising:

a substantially two-dimensional array of crystal cells,

each crystal cell having an empirical formula of Mₙ₊₁Xₙ, such that each X is positioned within an octahedral array of M,

wherein M is at least one Group IIIB, IVB, VB, or VIB metal,

wherein each X is C, N, or a combination thereof;

n=1, 2, 3, or 4; and wherein

Tₓ represents surface termination groups.

These so-called MXene compositions have been described in U.S. Pat. No. 9,193,595 and Application PCT/US2015/051588, filed Sep. 23, 2015, each of which is incorporated by reference herein in its entirety at least for its teaching of these compositions, their (electrical) properties, and their methods of making. That is, any such composition described in this Patent is considered as applicable for use in the present applications and methods and within the scope of the present invention. For the sake of completeness, M can be at least one of Sc, Y, Lu, Ti, Zr, Hf, V, Nb, Ta, Cr, Mo, or W. In certain embodiments in this class, M is at least one Group IVB, Group VB, or Group VIB metal, preferably Ti, Mo, Nb, V, or Ta. Certain of these compositions include those having one or more empirical formula wherein Mₙ₊₁Xₙ comprises Sc₂C, Ti₂C, V₂C, Cr₂C, Cr₂N, Zr₂C, Nb₂C, Hf₂C, Ti₃C₂, V₃C₂, Ta₃C₂, Ti₄C₃, V₄C₃, Ta₄C₃, Sc₂N, Ti₂N, V₂N, Cr₂N, Cr₂N, Zr₂N, Nb₂N, Hf₂C, Ti₃N₂, V₃C₂, Ta₃C₂, Ti₄N₃, V₄C₃, Ta₄N₃, Mo₄VC₄ or a combination or mixture thereof. In particular embodiments, the Mₙ₊₁Xₙ structure comprises Ti₃C₂, Ti₂C, Ta₄C₃ or (V_{1/2}Cr_{1/2})₃C₃. In some embodiments, M is Ti or Ta, and n is 1, 2, 3, or 4, for example having an empirical formula Ti₃C₂ or Ti₂C. In some of these embodiments, at least one of said surfaces of each layer has surface terminations comprising hydroxide, oxide, sub-oxide, or a combination thereof. In certain preferred embodiments, the MXene composition is described by a formula Mₙ₊₁Xₙ Tₓ, where Mₙ₊₁Xₙ are Ti₂CTₓ, Mo₂TiC₂Tₓ, Ti₃C₂Tₓ, or a combination thereof, and Tₓ is as described herein. Those embodiments wherein M is Ti, and n is 1 or 2, preferably 2, are especially preferred.

Additionally, or alternatively, the articles of manufacture and methods use compositions, wherein the two-dimensional transition metal carbide, nitrides, or carbonitride comprises a composition having at least one layer having first and second surfaces, each layer comprising:

a substantially two-dimensional array of crystal cells,

each crystal cell having an empirical formula of M′₂M″ₙXₙ₊₁, such that each X is positioned within an octahedral array of M′ and M″, and where M″n are present as individual two-dimensional array of atoms intercalated (sandwiched) between a pair of two-dimensional arrays of M′ atoms,

wherein M′ and M″ are different Group IIIB, IVB, VB, or VIB metals (especially where M′ and M″ are Ti, V, Nb, Ta, Cr, Mo, or a combination thereof),

wherein each X is C, N, or a combination thereof, preferably C; and

n=1 or 2.

These compositions are described in greater detail in Application PCT/US2016/028354, filed Apr. 20, 2016, which is incorporated by reference herein in its entirety at least for its teaching of these compositions and their methods of making. For the sake of completeness, in some embodiments, M′ is Mo, and M″ is Nb, Ta, Ti, or V, or a combination thereof. In other embodiments, n is 2, M′ is Mo, Ti, V, or a combination thereof, and M″ is Cr, Nb, Ta, Ti, or V, or a combination thereof. In still further embodiments, the empirical formula M′₂M″ₙXₙ₊₁ comprises Mo₂TiC₂, Mo₂VC₂, Mo₂TaC₂, Mo₂NbC₂, Mo₂Ti₂C₃, Cr₂TiC₂, Cr₂VC₂, Cr₂TaC₂, Cr₂NbC₂, Ti₂NbC₂, Ti₂TaC₂, V₂TaC₂, or V₂TiC₂, preferably Mo₂TiC₂, Mo₂VC₂, Mo₂TaC₂, or Mo₂NbC₂, or their nitride or carbonitride analogs. In still other embodiments, M′₂M″ₙXₙ₊₁ comprises Mo₂Ti₂C₃, Mo₂V₂C₃, Mo₂Nb₂C₃, Mo₂Ta₂C₃, Cr₂Ti₂C₃, Cr₂V₂C₃, Cr₂Nb₂C₃, Cr₂Ta₂C₃, Nb₂Ta₂C₃, Ti₂Nb₂C₃, Ti₂Ta₂C₃, V₂Ta₂C₃, V₂Nb₂C₃, or V₂Ti₂C₃, preferably Mo₂Ti₂C₃, Mo₂V₂C₃, Mo₂Nb₂C₃, Mo₂Ta₂C₃, Ti₂Nb₂C₃, Ti₂Ta₂C₃, or V₂Ta₂C₃, or their nitride or carbonitride analogs.

A MXene composition can also include, e.g., a layer comprising a two-dimensional array of crystal cells, each crystal cell having an empirical formula of M₅X₄, such that each X is positioned within an array of M, wherein M is at least one Group IIIB, IVB, VB, or VIB metal or a lanthanide, wherein each X is C, N, or a combination thereof.

A MXene composition can also include, e.g., a substantially two-dimensional array of crystal cells, the layer having a first surface and a second surface, each crystal cell having an empirical formula of M₅X₄(Tₛ), such that each X is positioned within an array of M, wherein M is at least one Group IIIB, IVB, VB, or VIB metal or a lanthanide, wherein each X is C, N, or a combination thereof, wherein at least one of the first surface and the second surface comprises surface terminations Tₛ, the surface terminations independently comprising alkoxide, alkyl, carboxylate, halide, hydroxide, hydride, oxide, sub-oxide, nitride, sub-nitride, sulfonate, thiol, or any combination thereof.

Each of these compositions having empirical crystalline formulae Mₙ₊₁Xₙ or M′₂M″ₙXₙ₊₁ (or M₅X₄(Tₛ)) are described in terms of comprising at least one layer having first and second surfaces, each layer comprising a substantially two-dimensional array of crystal cells. In some embodiments, these compositions comprise layers of individual two-dimensional cells. In other embodiments, the compositions comprise a plurality of stacked layers. Additionally, in some embodiments, at least one of said surfaces of each layer has surface terminations (optionally designated “Tₛ” or “Tₓ” or “T_{z}”) comprising alkoxide, carboxylate, halide, hydroxide, hydride, oxide, sub-oxide, nitride, sub-nitride, sulfide, thiol, or a combination thereof. In some embodiments, at least one of said surfaces of each layer has surface terminations comprising alkoxide, fluoride, hydroxide, oxide, sub-oxide, or a combination thereof. In still other embodiments, both surfaces of each layer have said surface terminations comprising alkoxide, fluoride, hydroxide, oxide, sub-oxide, or a combination thereof. As used herein the terms “sub-oxide,” “sub-nitride,” or “sub-sulfide” is intended to connote a composition containing an amount reflecting a sub-stoichiometric or a mixed oxidation state of the M metal at the surface of oxide, nitride, or sulfide, respectively. For example, various forms of titania are known to exist as TiOₓ, where x can be less than 2. Accordingly, the surfaces of the present invention can also contain oxides, nitrides, or sulfides in similar sub-stoichiometric or mixed oxidation state amounts.

In the present disclosure, these MXenes can comprise simple individual layers, a plurality of stacked layers, or a combination thereof. Each layer can independently comprise surfaces functionalized by any of the surface coating features described herein (e.g., as in alkoxide, carboxylate, halide, hydroxide, hydride, oxide, sub-oxide, nitride, sub-nitride, sulfide, thiol, or a combination thereof) or can be also partially or completely functionalized by polymers, either on the surface of individual layers, for example, where the two-dimensional compositions are embedded within a polymer matrix, or the polymers can be intercalated between layers to form structural composites, or both.

In certain applications, the MXene surface coatings can be adjusted to range from hydrophobic to hydrophilic, depending on post-synthesis treatment regimes.

The terms “MXenes” or “two-dimensional (2D) crystalline transition metal carbides” or two-dimensional (2D) transition metal carbides” can be used interchangeably to refer collectively to compositions described herein as comprising substantially two-dimensional crystal lattices of the general formulae Mₙ₊₁Xₙ(Tₛ), M₂A₂X(Tₛ). and M′₂M″ₙXₙ₊₁(Tₛ), where M, M′, M″, A, X, and Tₛ are defined herein. Supplementing the descriptions herein, Mₙ₊₁Xₙ(Tₛ) (including M′₂M″ₘXₘ₊₁(Tₛ) compositions) can be viewed as comprising free standing and stacked assemblies of two dimensional crystalline solids. Collectively, such compositions are referred to herein as “Mₙ₊₁Xₙ(Tₛ),” “MXene,” “MXene compositions,” or “MXene materials.” Additionally, these terms “Mₙ₊₁Xₙ(Tₛ),” “MXene,” “MXene compositions,” or “MXene materials” can also independently refer to those compositions derived by the chemical exfoliation of MAX phase materials, whether these compositions are present as free-standing 2-dimensional or stacked assemblies (as described further below). These compositions can be comprised of individual or a plurality of such layers. In some embodiments, the MXenes comprising stacked assemblies can be capable of, or have atoms, ions, or molecules, that are intercalated between at least some of the layers. In other embodiments, these atoms or ions are lithium.

The term “crystalline compositions comprising at least one layer having first and second surfaces, each layer comprising a substantially two-dimensional array of crystal cells” refers to the unique character of these materials. For purposes of visualization, the two-dimensional array of crystal cells can be viewed as an array of cells extending in an x-y plane, with the z-axis defining the thickness of the composition, without any restrictions as to the absolute orientation of that plane or axes. It is preferred that the at least one layer having first and second surfaces contain but a single two-dimensional array of crystal cells (that is, the z-dimension is defined by the dimension of approximately one crystal cell), such that the planar surfaces of said cell array defines the surface of the layer; it should be appreciated that real compositions can contain portions having more than single crystal cell thicknesses.

That is, as used herein, “a substantially two-dimensional array of crystal cells” refers to an array which preferably includes a lateral (in x-y dimension) array of crystals having a thickness of a single unit cell, such that the top and bottom surfaces of the array are available for chemical modification.

Data

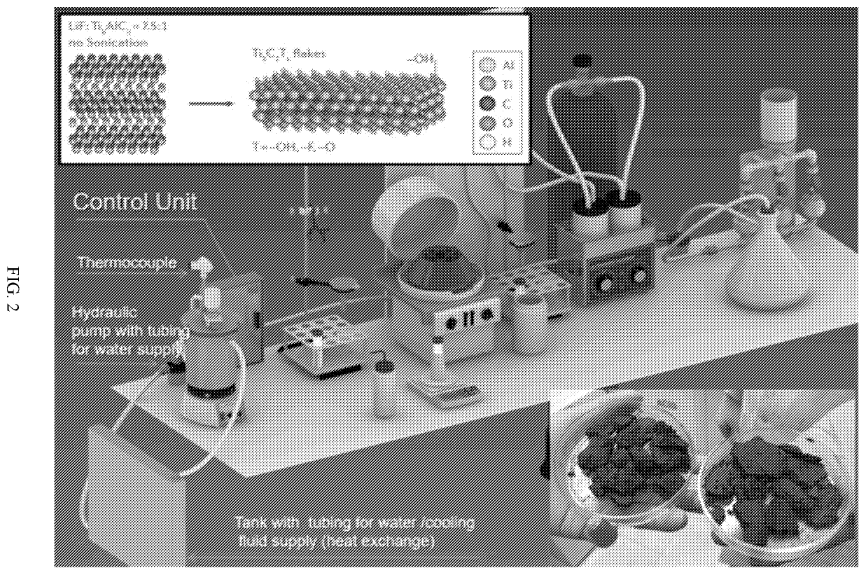

Studies tested Ti₃C₂Tₓ, produced by selective etching of the Al element with 5-30 wt. % HF from their ternary layered 3D Ti₃AlC₂ phase, as Toxic Industrial Chemicals (TIC) adsorbents. The Ti₃C₂Tₓ MXenes produced from these MAX phases are known to possess layered structures with high specific surface area with interlayer accessibility. The particle size of the Ti₃C₂Tₓ MXene powders used in the experiments was 100 μm. A detailed description of the Ti₃C₂Tₓ synthesis procedure can be found elsewhere, and Ti₃C₂Tₓ can be scaled up to kg quantities of high-quality MXenes with well-controlled surface chemistries, a process shown schematically in FIG. 2.

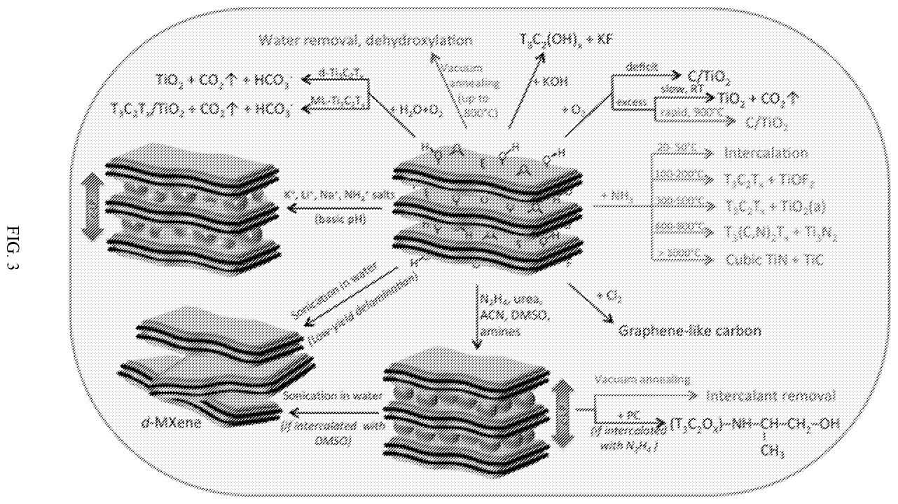

MXenes can be accurately described as Mₙ₊₁XₙTₓ (for example Ti₃C₂Tₓ) rather than Mₙ₊₁Xₙ, where, T represents surface terminations, such as —OH, ═O and/or F. These terminations have been predicted to play a major role in determining the multi-layer MXenes' sorption properties. Various cations, ranging from Li⁺ to Al³⁺ and tetramethylammonium N(CH₃)₄⁺, as well as small polar organic and inorganic molecules, such as DMSO, urea, amines or hydrazine, can intercalate MXenes (FIG. 3).

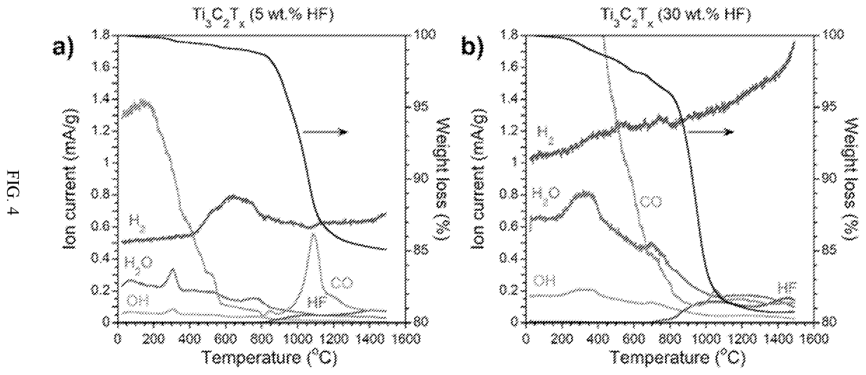

Studies on the control of surface terminations (Tₓ) (FIG. 4) provide means to significantly alter physical and chemical properties of this already chemically rich and versatile family of materials for selective sorption enhancement. Thermal Analysis-Mass Spectrometry (TA-MS) results (FIG. 4) show thermal stability for Ti₃C₂Tₓ MXene powders synthesized with 5 wt. % HF (FIG. 4a) and 30 wt. % HF (FIG. 4b) with the onset temperature 850° C. and 825° C., respectively. The results suggest that the stability of MXenes etched with 5 wt. % HF has improved. The weight loss between 800-1200° C. associated with the thermal decomposition of MXenes (CO gas evolution) is 12.6 wt. % and 14.9 wt. % for Ti₃C₂Tₓ etched with 5 wt. % HF and 30 wt. % HF, respectively.

A comparison of the MS data shows changes in the intensity of the regions corresponding to hydroxyl groups (—OH); fluoride terminations and structural water can be seen, which suggests their different surface chemistry. The larger amount of —OH, —F is released for Ti₃C₂Tₓ etched with 30 wt. % HF than for Ti₃C₂Tₓ etched with 5 wt. % HF. It is important to note significant contributions from the hydrogen thermal desorption for all MXenes. The feasibility of synthesizing Ti₃C₂Tₓ etched with 5 wt. % and 30 wt. % HF provides means to control MXenes' surface properties, involving polar vs. non-polar structures.

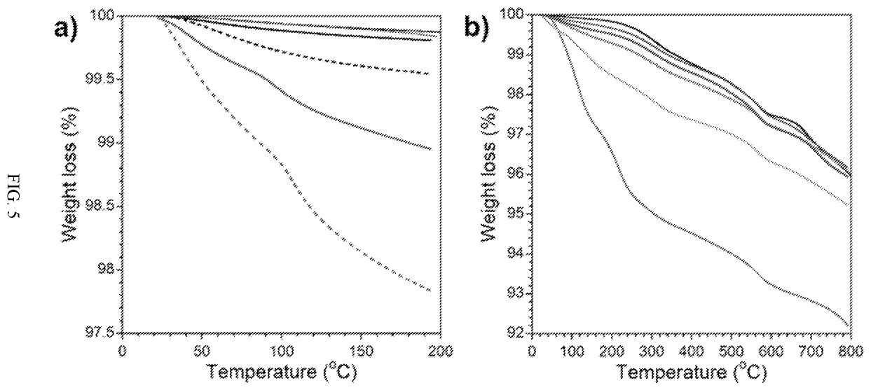

Results on the clutter rejection show high water rejection of the MXenes with 90% relative humidity (FIG. 5a). The amounts of water adsorbed are 0.88 wt. % and 1.86 wt. % after exposure to water vapor for 24 and 72 hours, respectively, for Ti₃C₂Tₓ powders synthesized with 30 wt. % HF, and 0.16 wt. % and 0.39 wt. % after exposure to water vapor for 24 and 72 hours, respectively, for Ti₃C₂Tₓ powders synthesized with 5 wt. % HF at ambient temperature and pressure.

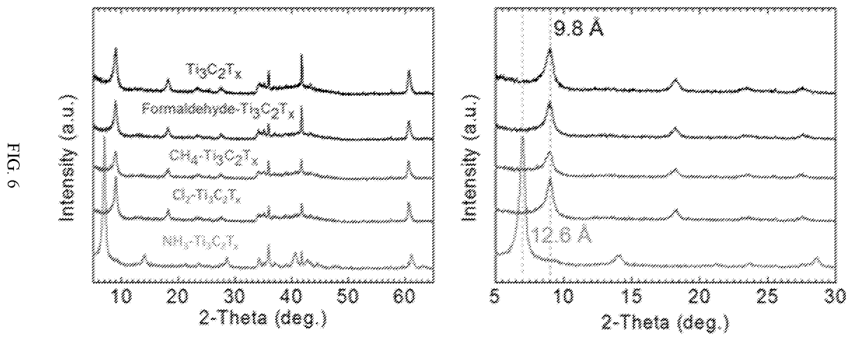

Recent results on adsorption of Toxic Industrial Chemicals on Ti₃C₂Tₓ powder synthesized with 30 wt. % HF show high and selective adsorption towards ammonia molecules. The adsorption capacity on Ti₃C₂Tₓ is 5.20 wt. % for ammonia, which is higher than carbide derived carbons with well-developed microporosity. Ammonia is adsorbed either via reaction with surface groups or intercalation within interlayer spacing of Ti₃C₂Tₓ. The first is responsible for strong adsorption. The presence of ammonia causes an increase in the distance between the Ti₃C₂Tₓ layers from 9.8 Å to 12.6 Å (FIG. 6). The layered structure and the abundance of hydroxyl groups on Ti₃C₂Tₓ results in its strong and selective adsorption capacity towards removal of ammonia. Ammonia and other TIC was released (Table1 1, second column) during He purging at room temperature, showing availability of analytes for chemical analysis.

The X-ray diffraction patterns (FIG. 6) show the (002) peaks reflecting the changes in the nature of the T₃C₂Tₓ by introduction of different TIC to the MXene layers; ammonia makes them more organized and expanded, while adsorption of CH₄ results in more chaotic spatial orientation of the layers.

TABLE 1
Sorption of Toxic Industrial Chemicals (TIC) on
Ti₃C₂Tₓ powder synthesized with 30 wt. % HF.

| | | | Release | Release |
|---|---|---|---|---|
| | | Release | between | between |
| | Capacity | at RT* | 25-100° C. | 25-800° C. |
| TIC Analytes | (wt. %) | (wt. %) | (wt. %) | (wt. %) |
| Acetone | 1.79 | 0.06 | 0.15 | 3.83 |
| Ammonia | 5.20 | 0.34 | 1.29 | 7.80 |
| Chlorine | 3.67 | 0.08 | 0.32 | 3.90 |
| Formaldehyde | 7.12 | 2.34 | 0.63 | 4.78 |
| Methane | 2.00 | 0.04 | 0.24 | 4.06 |

*RT—room temperature

Water adsorption: The initial Ti₃C₂Tₓ MXene powders were vacuum annealed at 200° C. to constant mass and placed in a tightly closed vessel with constant pressure of water vapor at ambient temperature and pressure. After 24 hours the TA tests were carried out using a TA instrument thermal analyzer (SDT Q 650, Discovery Series). The weight loss in helium between 30 and 150° C. was assumed as an equivalent to the quantity of water adsorbed on the surface.

Adsorption of Analytes: Adsorption tests were carried out under dry dynamic conditions at ambient temperature and pressure. Ti₃C₂Tₓ MXene powder synthesized with 30 wt. % HF was placed into a glass column with the mass of adsorbent 0.15 grams. Pure Ammonia (anhydrous), pure Chlorine and Methane (10% balanced in Argon) were then passed separately through the column with the adsorbent at 100 mL/min for 2 hours. Adsorption of Acetone (pure) and adsorption of Formaldehyde (37 w/w) were carried out from vapors of the analytes in a tightly closed vessel during 24 hours. After adsorption, the spent Ti₃C₂Tₓ MXene was immediately set up on thermal analysis (SDT Q 650, Discovery Series) and the weight change was monitored during 5 min in order to evaluate weakly adsorbed analytes. Afterwards, the spent MXene was heated up to 800° C. The adsorption capacities of each analyte in wt. % were calculated from weight changes.

Additional Results

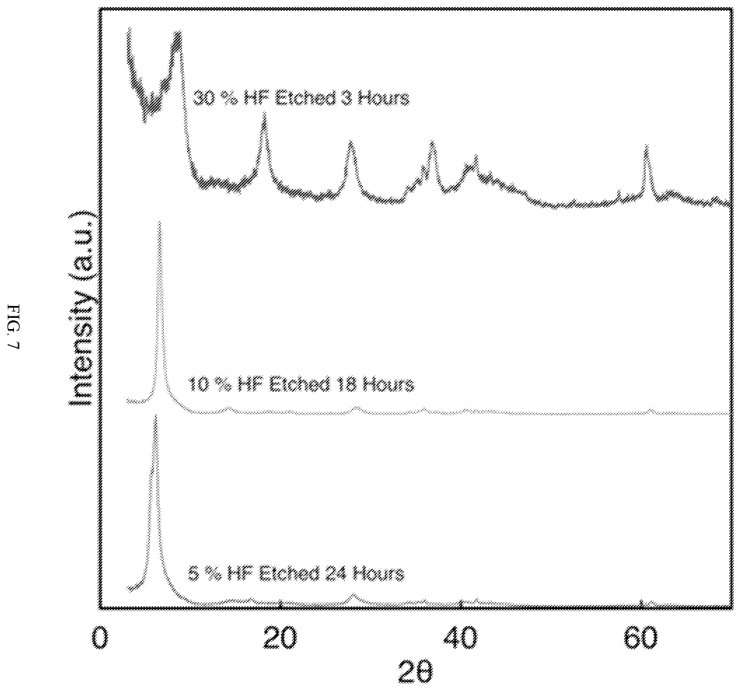

Using three different HF concentrations (5, 10, and 30% HF) for various times (24, 18, and 3 hours, respectively), the MAX phase material was topochemically converted into Ti₃C₂ MXene (FIG. 7). No difference was found in the XRD patterns for the different particle sizes. The XRD patterns indicate that the structures of the produced MXenes are different, with additional disorder caused by the higher HF etching conditions.

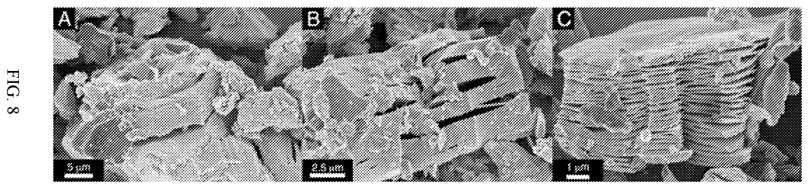

The resulting microstructure of these materials was studied (FIG. 8). From these, one can see that the higher HF concentrations lead to a more open structure. The 5 wt. % structures are still mostly closed, with the layer spacing only being slightly changed.

As the HF wt. % is increased, the structure becomes more open, with the 30 wt. % structures having the most open structure. Without being bound to any particular theory, this means that there can be a high propensity for gas adsorption with HF wt. %. Regardless of the particle size used, no qualitative differences could be seen in the SEM images.

The hydrophilic properties of MXenes promote the formation of hydrogen bonds between their hydroxyl groups and water. The surface functionality composition of MXenes can be controlled during the annealing process. Beyond 850° C., partial oxidation and phase transformation of MXenes takes place under He environment.

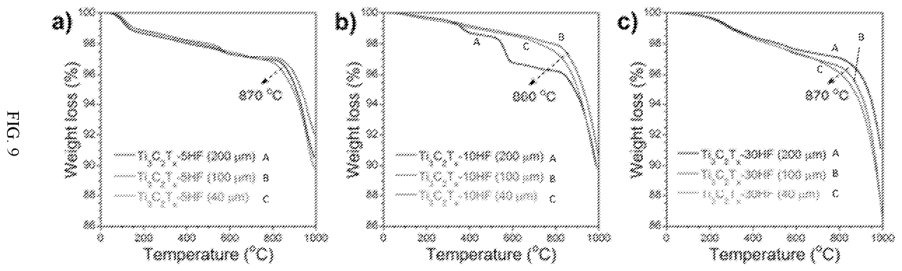

Though there is no external O₂ supply in the system, oxidation is caused by the reactive forms of oxygen, such as hydroxyl radicals and superoxide anions generated during heat treatment process. No difference in the weight loss changes for the different particle sizes, except for Ti₃C₂Tₓ-10HF with 100 μm due to synthesis conditions (FIG. 9). The heat treatment above a critical temperature of phase transformation, which is around 870° C., results in a chemical transformation, while below the critical temperature results in thermal desorption of surface terminations including hydroxyl, oxy and fluoride OH/═O/—F.

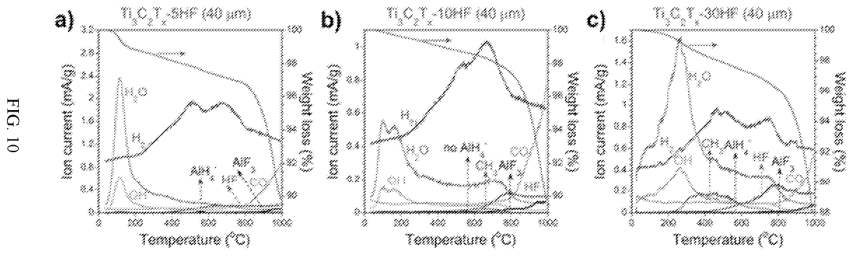

One finds no differences in the surface chemistry for the different particle sizes, slight changes in ion current is seen for intercalated species, such as AlH₄ and AlF₃. The first peak, centered at 100° C. is due to the release of entrapped water and is related to multilayer water (weak water-water interaction) with a continuous release both water and —OH groups up to 500° C., with structural (defect based interaction) for the second water peak at 200° C. The hydrophilic properties of MXenes promote the formation of hydrogen bonds between their hydroxyl groups and water (strong water-surface interaction) (FIG. 10). The H₂ gas released is due to a combination of —OH termination reactions and/or molecular hydrogen trapped in MXene structure. At around 450° C., the —F groups begin to be released in the form of HF.

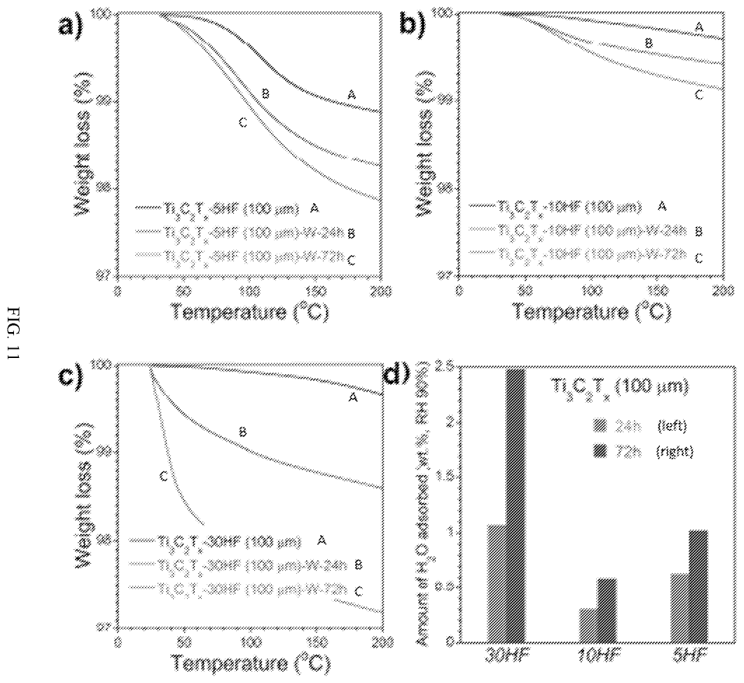

The initial Ti₃C₂Tₓ MXene powders were uniformly vacuum annealed at 200° C. to constant mass. The powders were then placed into a sealed vessel with constant water vapor pressure at ambient temperature. After 24 hours the tests were conducted using a thermal analyzer (SDT Q 650, Discovery Series). The weight loss in helium from 30-150° C. was assumed to be surface adsorbed water. The clutter rejection results (FIG. 11) show high MXene water rejection at 90% relative humidity. The amount of water adsorbed is 1.07 wt. %, 2.48 wt. %, and 7.68 wt. % after exposure to water vapor for 24, 72 hours and 9 days, respectively, for the 30 wt. % HF etched Ti₃C₂Tₓ. Ti₃C₂Tₓ synthesized with 5 and 10 wt. % HF show high water rejection due to the more closed structure than the 30 wt. % HF Ti₃C₂Tₓ.

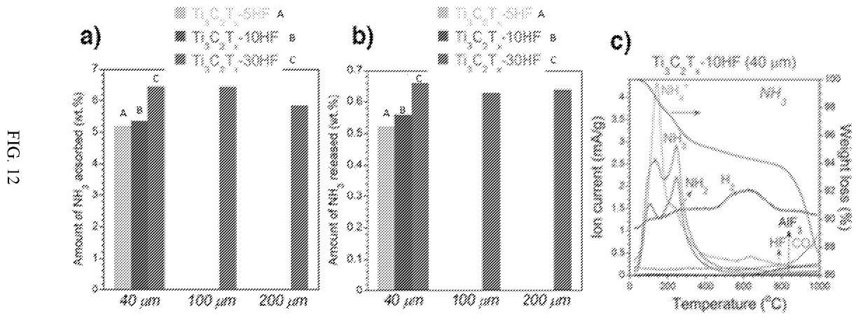

Adsorption tests were carried out under dry dynamic conditions at ambient temperature and pressure (FIG. 12). Ti₃C₂Tₓ MXene powder was placed into a glass column with 0.15 grams adsorbant. Pure anhydrous ammonia was flowed through the column with the adsorbent at 500 mL/min for 2 hours. After adsorption, thermal analysis was immediately conducted on the spent Ti₃C₂Tₓ MXene; the weight change was monitored for 1 hour to evaluate weakly adsorbed analytes. Afterwards, the spent MXene was heated to 1000° C. The adsorption capacities of each analyte in wt. % were calculated from the weight change. NH₃ adsorption on the Ti₃C₂Tₓ powder shows high and selective adsorption. The adsorption capacity of Ti₃C₂Tₓ is 6.4 wt. % for ammonia (FIG. 12a), which is higher than carbide derived carbons with well-developed microporosity. Up to 0.66 wt. % of ammonia was released during He purging at room temperature (FIG. 12b), showing the availability of analytes for chemical analysis. Ammonia is adsorbed either via reaction with surface groups or intercalation within the interlayer spacing of Ti₃C₂Tₓ. The first is responsible for strong adsorption. We found no change in the thermal stability after NH₃ adsorption compared to the initial Ti₃C₂Tₓ, and no change in the MXene structure (FIG. 12c). The first peak, centered at 130° C., is due to the release of entrapped NH₃ molecules with continuous release of ammonium ions up to 400° C.

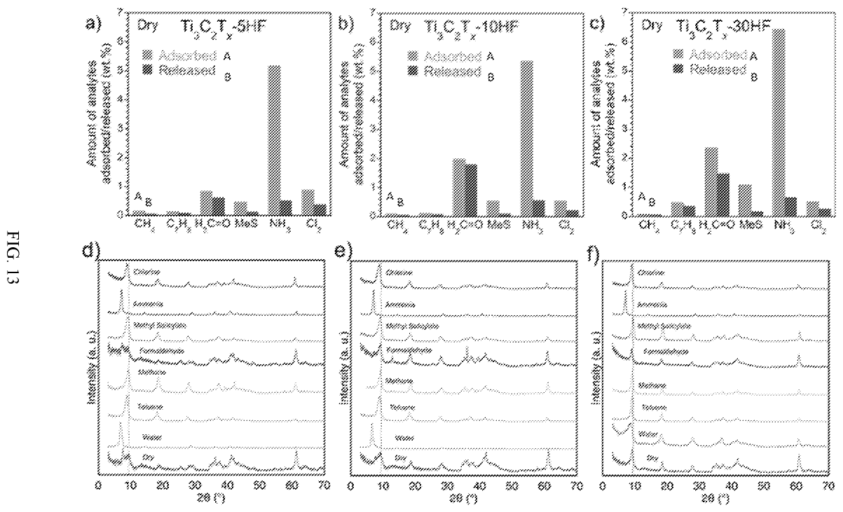

The gas adsorption properties of Ti₃C₂Tₓ were studied with different gases (FIG. 13). Adsorption of the molecules increases with polarity and basicity. The ammonia adsorbed most readily, followed by formaldehyde, chlorine gas, with methane and toluene being the worst. Molecules that weakly interact are easier to release. The adsorption capacity of formaldehyde on Ti₃C₂Tₓ is 2.4 wt. % for MXene obtained by etching Ti₃AlC₂ using 30 wt. % HF due to open structure. Over 50% formaldehyde was released during purging of He 1 hour at room temperature, showing physically adsorbed formaldehyde on the surface of MXenes. The difference in adsorption values is affected by the surface functionalizations, defect density, and layer separation. Due to the difference in structural and observed ammonia adsorption values, it is expected that MXenes etched with different conditions can have different adsorption and release capacities and rates. Furthermore, it is expected that materials with different chemistries can also show differing adsorptions. This allows the MXene family to be tailored with specific gases in mind or to general types of gases. From the XRD patterns (FIG. 13d, e, f), it is observed that the more polar molecules can intercalate between the MXene layers, leading to an increase in lattice size. For the nonpolar molecules, they did not readily intercalate between the MXene sheets, instead likely interacted with the MXene edges.

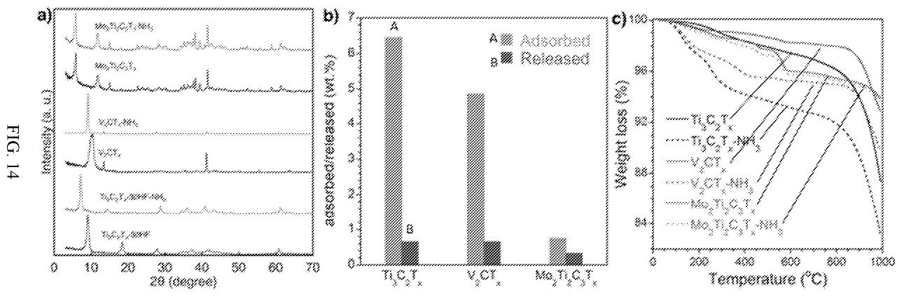

The adsorption properties of two different MXenes (V₂CTₓ and Mo₂Ti₂C₃Tₓ) were also studied (FIG. 14). V₂CTₓ was prepared by etching V₂AlC in a mixture of HF:HCl:H₂O with a 12:12:6 volume ratio for 96 hours at 35° C. Mo₂Ti₂C₃Tₓ was prepared by etching Mo₂Ti₂AlC₃ in 30% HF for 96 h at 55° C. These two MXenes were chosen because they comprise every major class of MXenes, representing varying thicknesses (n=1, V₂CTₓ; n=2 Ti₃C₂Tₓ; and n=3, Mo₂Ti₂C₃Tₓ), three different chemistries, and both single-M and double-M MXenes.

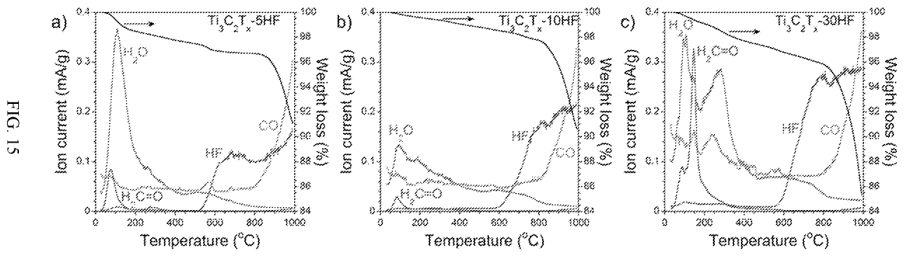

The adsorption capacity of NH₃ on Ti₃C₂Tₓ is 6.45 wt. %. This adsorption capacity is the higher than the other MXenes studied: V₂CTₓ (4.86 wt. %) and Mo₂Ti₂C₃Tₓ (0.75 wt. %) due to the differences in the composition/surface chemistry. This implies that every different MXene can adsorb gases at different quantities, allowing the gas adsorption properties to be tuned based on the chemistry and synthesis conditions. No change in the thermal stability for all MXenes was observed after TIC adsorption (FIG. 14c, FIG. 15), indicating lack of MXene degradation.

These results indicate that there are two significant methods for tunability of MXene gas adsorption properties that were studied. The first is through different etching conditions, it was shown that different HF concentrations lead to different structures with different degrees of accessibility of the basal planes (FIG. 8) and different surface functionalizations (FIG. 10), both of these effects play a role in the gas adsorption properties. And, considering for this study, only pure HF etching was utilized, it is also possible to use a different etching method (LiF+HCl, HF/HCl, HF/H₂SO₄, molten salts, etc.) to lead to further tailored surface chemistries and structures. Secondly, the MXene chosen itself leads to different gas adsorptive properties. It was shown that different MXenes (V-based or Mo-based; FIG. 14) lead to very different results with only one TIC considered, however, it is likely that there would be different relative gas adsorption properties for each type of gas, leading to the possibility of developing an array of MXenes for simultaneous adsorption and sensing. Furthermore, while not considered for this work, different surface treatments (grafting, delamination, co-adsorbents, etc.) can change the gas adsorption properties additionally, and different MXene structures (fibers, aerogels, films, etc.) can have further modified adsorption properties. Each of these different routes adds another layer of tunability and control.

Aspects

The following Aspects are exemplary only and do not limit the scope of the present disclosure or the appended claims.

Aspect 1. A method of adsorbing an analyte, comprising: contacting a MXene composition with the analyte, the contacting resulting in selective adsorption of the analyte to the MXene composition. It should be understood that a user can contact the MXene composition with one, two, or more analytes.

As described elsewhere herein, adsorption can be accomplished by one or both of reaction by the analyte with surface groups of the MXene composition or by intercalation of the analyte within interlayer spacing of MXenes.

The MXene can be selected such that the MXene adsorbs sufficient analyte such that the analyte represents from about 0.01 to about 10% of the weight of the combined weight of the MXene composition and the analyte, or from about 0.1 to about 9 wt. %, or from about 0.5 to about 8 wt. %, or from about 1 to about 7 wt. %, or from about 2 to about 6.5 wt. %. The amount of ammonia adsorbed is 6.09 wt. %, and 1.07 wt. % and 2.48 wt. % after exposure to water vapor for 24 and 72 hours, respectively, for the 30 wt. % HF etched Ti₃C₂Tₓ.

Aspect 2. The method of Aspect 1, wherein the MXene composition is any one of the MXene compositions set forth or referenced herein or made by any of the methods set forth or referenced herein.

Aspect 3. The method of any one of Aspects 1-2, wherein the MXene composition comprises a surface termination that comprises alkoxide, carboxylate, halide, hydroxide, hydride, oxide, sub-oxide, nitride, sub-nitride, sulfide, thiol, or a combination thereof.

The MXene composition can include layers wherein each layer can independently comprise surfaces functionalized by any of the surface coating features described herein (e.g., as in alkoxide, carboxylate, halide, hydroxide, hydride, oxide, sub-oxide, nitride, sub-nitride, sulfide, thiol, or a combination thereof) or can be also partially or completely functionalized by polymers, either on the surface of individual layers, for example, where the two-dimensional compositions are embedded within a polymer matrix, or the polymers can be intercalated between layers to form structural composites, or both. A given MXene composition can include a mixture of terminations, e.g., one or more layers or parts of layers that include —OH terminations and one or more layers or parts of layers that include —F terminations. A composition (or device or component) according to the present disclosure can include one MXene composition or even a plurality of MXene compositions, with the MXenes composition differing in terms of one or more of their M elements, their X elements, their surface terminations, their density of surface terminations, or any combination thereof. As an example, a component according to the present disclosure can include a first MXene composition that comprises —F terminations and a second MXene composition that includes —OH terminations. A user can select MXene compositions (and/or surface terminations) on the basis of water rejection and/or affinity for a given analyte.

Aspect 4. The method of any one of Aspects 1-3, wherein the MXene composition is characterized as being in the form of a suspension, a powder, a gel, a film, a fabric, a composite, a fiber, or any combination thereof. The MXene composition can be in the form of a cartridge, a filter, or other body to which media is contacted or through which media is passed.

Aspect 5. The method of any one of Aspects 1-4, wherein the analyte is characterized as a toxic industrial chemical, a nerve agent, a simulant, an opioid, a narcotic, a cholinesterase inhibitor, a blood agent, or any combination thereof.

Aspect 6. The method of any one of Aspects 1-5, wherein the MXene composition is configured so as to preferentially reject at least one of water and a hydrocarbon relative to the analyte.

Aspect 7. The method of any one of Aspects 1-6, further comprising effecting conditions so as to release at least some of the analyte adsorbed to the MXene composition. Such conditions can include, e.g., a change in temperature (whether gradual or step-wise), a change in pH, application of a current, introduction of a further chemical species, vibration, and the like.

Temperature can be increased and held at a given value before being changed again and then held at a different value. Temperature can be cycled between two or more values.

A current can be applied (or released) so as to effect release of at least some of the analyte adsorbed to the MXene composition. A further chemical species (e.g., purging with a noble gas, introduction of another analyte that displaces the analyte adsorbed to the MXene) can also be introduced to effect release of adsorbed analyte. Thus, in addition to thermal release, it is possible to use electrical current to release analytes, or to use a supercritical fluid of some sort. One can also place the sorbent in a vacuum, which can in turn to desorption of some adsorbed species.

The methods can further include analyzing material that has been released from the MXene composition. Such analysis can be, e.g., gas chromatography, or other analysis methods known to those of ordinary skill in the art. Such analysis can be performed so as to determine the presence (or absence) of a given analyte, e.g., to rule in (or rule out) the presence of the analyte in media initially contacted to the MXene composition. As but one example, one can contact the MXene composition with media (e.g., a water sample) suspected of including an analyte of interest. Following such contact, the user can flush the MXene composition with, e.g., helium, at a temperature known to give rise to release of the analyte (if present) from the MXene composition for a duration of time also known to give rise to release of the analyte from the MXene composition. The user can then collect and/or monitor downstream of the MXene composition to determine whether any of the analyte has (or has not) been released from the MXene, thereby confirming the presence of absence of the analyte from the original media contacted to the MXene composition.

The methods can be performed in a manual fashion, e.g., wherein temperature is controlled manually. Alternatively, the methods can be performed in an at least partially automated fashion, in which one or more steps (e.g., control of temperature) is performed in an automated fashion.

The methods can include screening for multiple analytes. In this manner, the methods can include exposing to a medium two (or more) MXene compositions, with each MXene composition being configured to preferentially adsorb a different analyte. A user can then, by processing each MXene composition under conditions sufficient to release the analyte preferentially adsorbed by that MXene, determine the presence (or absence) of each of those analytes in the medium. A user can also expose to the medium a MXene that releasably adsorbs two or more analytes. In this way, the user can then process the MXene composition under conditions sufficient to release the analytes adsorbed by that MXene, and then determine the presence (or absence) of each of those analytes in the medium.

Aspect 8. A selective adsorption system, comprising: a MXene composition, the MXene composition being configured for placement into fluid communication with an analyte. As described elsewhere herein, the MXene can be in the form of a cartridge, a filter, a monolith, and the like.

Aspect 9. The selective adsorption system of Aspect 8, wherein the MXene composition is characterized as being in the form of a suspension, a powder, a gel, a film, a fabric, a composite, a fiber, or any combination thereof.

Aspect 10. The selective adsorption system of any one of Aspects 8-9, wherein the MXene composition comprises a surface termination that comprises alkoxide, carboxylate, halide, hydroxide, hydride, oxide, sub-oxide, nitride, sub-nitride, sulfide, thiol, or a combination thereof.

Aspect 11. The selective adsorption system of any one of Aspects 8-9, wherein the MXene composition is in communication with a sensor configured to detect the presence of the analyte adsorbed to the MXene. The sensor can be configured to detect the presence of the analyte at the time the analyte is absorbed to the MXene. Alternatively, the sensor can be configured to detect the presence of the analyte following the analyte's release from the MXene, e.g., release effected by temperature, flushing with other chemical species, application of current, change in pH, or any combination thereof. A sensor can monitor an electronic property (e.g., resistance, capacitance, and the like) of the MXene composition, which electronic property can indicate the presence (or absence) of the analyte of interest.

As a non-limiting example, a system can include a MXene composition (or compositions) that selectively adsorb one or more analytes. The system can also include a sensor (balance, mass spectrometer, for example) configured to determine a weight, an electrical characteristic, an optical characteristic, or another characteristic of MXene composition, which sensor can provide information regarding the adsorption of the analyte to the MXene composition, desorption of the analyte to the MXene composition. A system can also include a sensor configured to determine a weight or other characteristic of a species that has desorbed from the MXene composition. The system can be configured to place the MXene composition into fluid communication with a sample, and the system can also be configured to be self-contained so as not to allow the escape of desorbed analyte.

Aspect 12. An analyte storage system, comprising a MXene composition configured to selectively adsorb a first analyte (e.g., from a medium), the first analyte optionally comprising a gas.

Aspect 13. The analyte storage system of Aspect 12, the system being configured to effect release of the first analyte adsorbed to the MXene composition. As described elsewhere herein, the release can be effected by elevated temperature, changed pH, application of a current, vibration, application of other chemical species, or any combination thereof.

The system can include a heating element configured to increase a temperature of the MXene composition, a source of acid and/or a source of base configured to effect a change of pH at the MXene composition, a source of current configured to apply a current to the MXene composition, or any combination thereof. The system can also include a sensor (e.g., a gas chromatograph) configured to determine the presence (or absence) of the analyte in media (e.g., a carrier fluid, such as a gas) that has contacted the MXene.

Aspect 14. The analyte storage system of any one of Aspects 12-13, the system being configured to support a chemical reaction on the first analyte adsorbed to the MXene composition.

Aspect 15. A method, comprising: contacting a MXene composition to a medium suspected of containing at least one analyte, the contacting being performed under conditions sufficient to support adsorption of the analyte to the MXene composition; exposing the MXene composition to conditions sufficient to release adsorbed analyte, if present, from the MXene composition. A user can evaluate the MXene composition for weight loss/gain, thereby determining the presence, absence, accumulation, or desorption of the at least one analyte.

Aspect 16. The method of Aspect 15, wherein the at least one MXene composition is configured to selectively adsorb a first analyte and a second analyte from the medium.

Aspect 17. The method of Aspect 16, wherein the at least one MXene composition is exposed to conditions sufficient to release the first analyte from the MXene composition and to release the second analyte from the MXene composition.

Aspect 18. The method of Aspect 17, wherein the conditions sufficient to release the first analyte from the MXene composition differ from the conditions sufficient to release the second analyte from the MXene composition. As an example, the adsorbed first analyte can release from the MXene composition at a lower temperature than adsorbed second analyte.

Aspect 19. The method of any one of Aspects 15-18, wherein the method is performed in a manual fashion.

Aspect 20. The method of any one of Aspects 15-18, wherein the method is performed in an automated fashion.

As a non-limiting example, one can utilize a balance, a mass spectrometer, or other sensor to detect quantity and type of desorbed (analyte) species contained in the system. The MXene composition can adsorb the analyte, the MXene composition is then heated (or exposed to a current, a vacuum, and/or a supercritical fluid), and the sensor would measure the amount and type released. Such a system can be self-contained so as not to allow desorbed analyte to escape. One can also perform sensing based on a conductivity change (of the MXene composition) as a result of adsorption. Further, an analyte can be identified using a fiber-optic portable Raman spectrometer, which is an especially practical solution for in-field analysis.

### REFERENCES

C. Berger, Z. Song, T. Li, X. Li, A. Y. Ogbazghi, R. Feng, Z. Dai, A. N. Marchenkov, E. H. Conrad, P. N. First, W. A. de Heer, Ultrathin Epitaxial Graphite: 2D electron gas properties and a route toward graphene-based nanoelectronics, The Journal of Physical Chemistry B, 108 (2004) 19912-19916.
W. A. de Heer, C. Berger, M. Ruan, M. Sprinkle, X. Li, Y. Hu, B. Zhang, J. Hankinson, E. Conrad, Large area and structured epitaxial graphene produced by confinement controlled sublimation of silicon carbide, Proceedings of the National Academy of Sciences, 108 (2011) 16900-16905.
Y.-M. Lin, C. Dimitrakopoulos, K. A. Jenkins, D. B. Farmer, H.-Y. Chiu, A. Grill, P. Avouris, 100-GHz transistors from wafer-scale epitaxial graphene, Science, 327 (2010) 662.
R. Lv, J. A. Robinson, R. E. Schaak, D. Sun, Y. Sun, T. E. Mallouk, M. Terrones, Transition metal dichalcogenides and beyond: Synthesis, properties, and applications of single- and few-layer nanosheets, Accounts of Chemical Research, 48 (2015) 56-64.
V. Nicolosi, M. Chhowalla, M. G. Kanatzidis, M. S. Strano, J. N. Coleman, Liquid exfoliation of layered materials, Science, 340 (2013).
Y. Gong, Z. Liu, A. R. Lupini, G. Shi, J. Lin, S. Najmaei, Z. Lin, A. L. Elias, A. Berkdemir, G. You, H. Terrones, M. Terrones, R. Vajtai, S. T. Pantelides, S. J. Pennycook, J. Lou, W. Zhou, P. M. Ajayan, Band gap engineering and layer-by-layer mapping of selenium-doped molybdenum disulfide, Nano Letters, 14 (2013) 442-449.
S. Z. Butler, S. M. Hollen, L. Cao, Y. Cui, J. A. Gupta, H. R. Gutierrez, T. F. Heinz, S. S. Hong, J. Huang, A. F. Ismach, E. Johnston-Halperin, M. Kuno, V. V. Plashnitsa, R. D. Robinson, R. S. Ruoff, S. Salahuddin, J. Shan, L. Shi, M. G. Spencer, M. Terrones, W. Windl, J. E. Goldberger, Progress, challenges, and opportunities in two-dimensional materials beyond graphene, ACS Nano, 7 (2013) 2898-2926.
J. Taha-Tijerina, T. N. Narayanan, G. Gao, M. Rohde, D. A. Tsentalovich, M. Pasquali, P. M. Ajayan, Electrically insulating thermal nano-oils using 2D fillers, ACS Nano, 6 (2012) 1214-1220.
A. Geim, I. Grigorieva, Van der Waals heterostructures, Nature, 499 (2013) 419-425.
Q. H. Wang, K. Kalantar-Zadeh, A. Kis, J. N. Coleman, M. S. Strano, Electronics and optoelectronics of two-dimensional transition metal dichalcogenides, Nature nanotechnology, 7 (2012) 699-712.
M. Osada, T. Sasaki, Exfoliated oxide nanosheets: new solution to nanoelectronics, Journal of Materials Chemistry, 19 (2009) 2503-2511.
W. Sugimoto, H. Iwata, Y. Yasunaga, Y. Murakami, Y. Takasu, Preparation of ruthenic acid nanosheets and utilization of its interlayer surface for electrochemical energy storage, Angewandte Chemie International Edition, 42 (2003) 4092-4096.
X. Rui, Z. Lu, H. Yu, D. Yang, H. H. Hng, T. M. Lim, Q. Yan, Ultrathin V₂O₅ nanosheet cathodes: realizing ultrafast reversible lithium storage, Nanoscale, 5 (2013) 556-560.
S. T. Oyama, The Chemistry of Transition Metal Carbides and Nitrides, Springer, 1996.
Y. G. Gogotsi, R. A. Andrievski, Materials Science of Carbides, Nitrides and Borides, in, Kluwer, Dordrecht, N L, 1999.
K. Yvon, W. Rieger, H. Nowotny, Die Kristallstruktur von V₂C, Monatshefte für Chemie and verwandte Teile anderer Wissenschaften, 97 (1966) 689-694.
M. Naguib, M. Kurtoglu, V. Presser, J. Lu, J. Niu, M. Heon, L. Hultman, Y. Gogotsi, M. W. Barsoum, Two-dimensional nanocrystals produced by exfoliation of Ti₃AlC₂, Advanced Materials, 23 (2011) 4248-4253.
M. Naguib, O. Mashtalir, J. Carle, J. Lu, L. Hultman, Y. Gogotsi, M. W. Barsoum, Two-dimensional transition metal carbides, ACS Nano, 6 (2012) 1322-1331.
M. Naguib, V. N. Mochalin, M. W. Barsoum, Y. Gogotsi, MXenes: A new family of two dimensional materials, Advanced Materials, 26 (2014) 992-1005.
M. W. Barsoum, MAX Phases: Properties of Machinable Ternary Carbides and Nitrides, John Wiley & Sons, 2013.
M. Naguib, J. Come, B. Dyatkin, V. Presser, P.-L. Taberna, P. Simon, M. W. Barsoum, Y. Gogotsi, MXene: a promising transition metal carbide anode for lithium-ion batteries, Electrochemistry Communications, 16 (2012) 61-64.
O. Mashtalir, M. Naguib, V. N. Mochalin, Y. Dall'Agnese, M. Heon, M. W. Barsoum, Y. Gogotsi, Intercalation and delamination of layered carbides and carbonitrides, Nature Communications, 4 (2013) 1716.
M. Naguib, J. Halim, J. Lu, K. M. Cook, L. Hultman, Y. Gogotsi, M. W. Barsoum, New two-dimensional niobium and vanadium carbides as promising materials for Li-ion batteries, Journal of the American Chemical Society, 135 (2013) 15966-15969.
Q. Tang, Z. Zhou, P. Shen, Are MXenes promising anode materials for Li ion batteries? Computational studies on electronic properties and Li storage capability of Ti₃C₂ and Ti₃C₂X₂ (X═F, OH) monolayer, Journal of the American Chemical Society, 134 (2012) 16909-16916.
Y. Xie, M. Naguib, V. N. Mochalin, M. W. Barsoum, Y. Gogotsi, X. Yu, K.-W. Nam, X.-Q. Yang, A. I. Kolesnikov, P. R. C. Kent, Role of surface structure on Li-ion energy storage capacity of two-dimensional transition-metal carbides, Journal of the American Chemical Society, 136 (2014) 6385-6394.
S. Zhao, W. Kang, J. Xue, Role of strain and concentration on the Li adsorption and diffusion properties on Ti₂C layer, The Journal of Physical Chemistry C, 118 (2014) 14983-14990.
Y. Xie, Y. Dall'Agnese, M. Naguib, Y. Gogotsi, M. W. Barsoum, H. L. Zhuang, P. R. C. Kent, Prediction and characterization of MXene nanosheet anodes for non-lithium-ion batteries, ACS Nano, 8 (2014) 9606-9615.
D. Er, J. Li, M. Naguib, Y. Gogotsi, V. B. Shenoy, Ti₃C₂ MXene as a high capacity electrode material for metal (Li, Na, K, Ca) ion batteries, ACS Applied Materials & Interfaces, 6 (2014) 11173-11179.
Q. Hu, D. Sun, Q. Wu, H. Wang, L. Wang, B. Liu, A. Zhou, J. He, MXene: A new family of promising hydrogen storage medium, The Journal of Physical Chemistry A, 117 (2013) 14253-14260.
Q. Hu, H. Wang, Q. Wu, X. Ye, A. Zhou, D. Sun, L. Wang, B. Liu, J. He, Two-dimensional Sc₂C: A reversible and high-capacity hydrogen storage material predicted by first-principles calculations, International Journal of Hydrogen Energy, 39 (2014) 10606-10612.
K. S. Novoselov, A. K. Geim, S. V. Morozov, D. Jiang, Y. Zhang, S. V. Dubonos, I. V. Grigorieva, A. A. Firsov, Electric field effect in atomically thin carbon films, Science, 306 (2004) 666-669.
M. Lukatskaya, O. Mashtalir, C. E. Ren, Y. Dall'Agnese, P. Rozier, P. L. Taberna, M. Naguib, P. Simon, M. W. Barsoum, Y. Gogotsi, Cation intercalation and high volumetric capacitance of two-dimensional titanium carbide, Science, 341 (2013) 1502.
M. Khazaei, M. Arai, T. Sasaki, C. Y. Chung, N. S. Venkataramanan, M. Estili, Y. Sakka, Y. Kawazoe, Novel electronic and magnetic properties of two-dimensional transition metal carbides and nitrides, Advanced Functional Materials, 23 (2013) 2185-2192.
Y. Xie, P. R. C. Kent, Hybrid density functional study of structural and electronic properties of functionalized Tiₙ₊₁Xₙ (X═C, N) monolayers, Physical Review B, 87 (2013) 235441.
M. Kurtoglu, M. Naguib, Y. Gogotsi, M. W. Barsoum, First principles study of two-dimensional early transition metal carbides, MRS Communications, 2 (2012) 133-137.
C. Eames, M. S. Islam, Ion intercalation into two-dimensional transition-metal carbides: Global screening for new high capacity battery materials, Journal of the American Chemical Society, 136 (2014) 16270-16276.
Q. Peng, J. Guo, Q. zhang, J. Xiang, B. Liu, A. Zhou, R. Liu, Y. Tian, Unique lead adsorption behavior of activated hydroxyl group in two-dimensional titanium carbide, Journal of the American Chemical Society, 136 (2014) 4113-4116.
Y. Ying, Y. Liu, X. Wang, Y. Mao, W. Cao, P. Hu, X. Peng, Two-dimensional titanium carbide for efficiently reductive removal of highly toxic chromium(VI) from water, ACS Applied Materials & Interfaces, 7 (2015) 1795-1803.
X. Li, G. Fan, C. Zeng, Synthesis of ruthenium nanoparticles deposited on graphene-like transition metal carbide as an effective catalyst for the hydrolysis of sodium borohydride, International Journal of Hydrogen Energy, 39 (2014) 14927-14934.
X. Xie, S. Chen, W. Ding, Y. Nie, Z. Wei, An extraordinarily stable catalyst: Pt NPs supported on two-dimensional Ti₃C₂X₂ (X═OH, F) nanosheets for oxygen reduction reaction, Chemical Communications, 49 (2013) 10112-10114.
X. Xie, Y. Xue, L. Li, S. Chen, Y. Nie, W. Ding, Z. Wei, Surface Al leached Ti₃AlC₂ as a substitute for carbon for use as a catalyst support in a harsh corrosive electrochemical system, Nanoscale, 6 (2014) 11035-11040.
F. Wang, C. Yang, C. Duan, D. Xiao, Y. Tang, J. Zhu, An organ-like titanium carbide material (MXene) with multilayer structure encapsulating hemoglobin for a mediator-free biosensor, Journal of the Electrochemical Society, 162 (2014) B16-B21.
J. Chen, K. Chen, D. Tong, Y. Huang, J. Zhang, J. Xue, Q. Huang, T. Chen, CO₂ and temperature dual responsive “Smart” MXene phases, Chemical Communications, 51 (2015) 314-317.
J. Yang, B. Chen, H. Song, H. Tang, C. Li, Synthesis, characterization, and tribological properties of two-dimensional Ti₃C₂, Crystal Research and Technology, 49 (2014) 926-932.
Z. Li, L. Wang, D. Sun, Y. Zhang, B. Liu, Q. Hu, A. Zhou, Synthesis and thermal stability of two-dimensional carbide MXene Ti₃C₂, Materials Science and Engineering: B, 191 (2015) 33-40.
J. Li, Y. Du, C. Huo, S. Wang, C. Cui, Thermal stability of two-dimensional Ti₂C nanosheets, Ceramics International, 41 (2014) 2631-2635.
S. Zhao, W. Kang, J. Xue, MXene nanoribbons, Journal of Materials Chemistry C, 3 (2015) 879-888.
X. Zhang, M. Xue, X. Yang, Z. Wang, G. Luo, Z. Huang, X. Sui, C. Li, Preparation and tribological properties of Ti₃C₂(OH)₂ nanosheets as additives in base oil, RSC Advances, 5 (2015) 2762-2767.
S. Zhao, W. Kang, J. Xue, Manipulation of electronic and magnetic properties of M₂C (M=Hf, Nb, Sc, Ta, Ti, V, Zr) monolayer by applying mechanical strains, Applied Physics Letters, 104 (2014) 133106.
Y. Gao, L. Wang, Z. Li, A. Zhou, Q. Hu, X. Cao, Preparation of MXene-Cu₂O nanocomposite and effect on thermal decomposition of ammonium perchlorate, Solid State Sciences, 35 (2014) 62-65.
D. Sun, M. Wang, Z. Li, G. Fan, L.-Z. Fan, A. Zhou, Two-dimensional Ti₃C₂ as anode material for Li-ion batteries, Electrochemistry Communications, 47 (2014) 80-83.
Z. Ma, Z. Hu, X. Zhao, Q. Tang, D. Wu, Z. Zhou, L. Zhang, Tunable band structures of heterostructured bilayers with transition-metal dichalcogenide and MXene monolayer, The Journal of Physical Chemistry C, 118 (2014) 5593-5599.
S. Wang, J.-X. Li, Y.-L. Du, C. Cui, First-principles study on structural, electronic and elastic properties of graphene-like hexagonal Ti₂C monolayer, Computational Materials Science, 83 (2014) 290-293.
F. Chang, C. Li, J. Yang, H. Tang, M. Xue, Synthesis of a new graphene-like transition metal carbide by de-intercalating Ti₃AlC₂, Materials Letters, 109 (2013) 295-298.
I. R. Shein, A. L. Ivanovskii, Graphene-like titanium carbides and nitrides Tiₙ₊₁Cₙ, Tiₙ₊₁Nₙ (n=1, 2, and 3) from de-intercalated MAX phases: First-principles probing of their structural, electronic properties and relative stability, Computational Materials Science, 65 (2012) 104-114.
I. R. Shein, A. L. Ivanovskii, Planar nano-block structures Tiₙ₊₁Al_{0.5}Cₙ and Tᵢₙ₊₁Cₙ (n=1, and 2) from MAX phases: Structural, electronic properties and relative stability from first principles calculations, Superlattices and Microstructures, 52 (2012) 147-157.
A. N. Enyashin, A. L. Ivanovskii, Two-dimensional titanium carbonitrides and their hydroxylated derivatives: Structural, electronic properties and stability of MXenes Ti₃C₂-xNx(OH)₂ from DFTB calculations, Journal of Solid State Chemistry, 207 (2013) 42-48.
A. L. Ivanovskii, A. N. Enyashin, Graphene-like transition-metal nanocarbides and nanonitrides, Russian Chemical Reviews, 82 (2013) 735.
M. Khazaei, M. Arai, T. Sasaki, M. Estili, Y. Sakka, The effect of the interlayer element on the exfoliation of layered Mo₂AC (A=Al, Si, P, Ga, Ge, As or In) MAX phases into two-dimensional Mo₂C nanosheets, Science and Technology of Advanced Materials, 15 (2014) 014208.
M. Khazaei, M. Arai, T. Sasaki, M. Estili, Y. Sakka, Two-dimensional molybdenum carbides: potential thermoelectric materials of the MXene family, Physical Chemistry Chemical Physics, 16 (2014) 7841-7849.
V. Mauchamp, M. Bugnet, E. P. Bellido, G. A. Botton, P. Moreau, D. Magne, M. Naguib, T. Cabioc'h, M. W. Barsoum, Enhanced and tunable surface plasmons in two-dimensional Ti₃C₂ stacks: Electronic structure versus boundary effects, Physical Review B, 89 (2014) 235428.
Y. Dall'Agnese, M. R. Lukatskaya, K. M. Cook, P.-L. Taberna, Y. Gogotsi, P. Simon, High capacitance of surface-modified 2D titanium carbide in acidic electrolyte, Electrochemistry Communications, 48 (2014) 118-122.
E. Yang, H. Ji, J. Kim, H. Kim, Y. Jung, Exploring the possibilities of two-dimensional transition metal carbides as anode material for sodium batteries, Physical Chemistry Chemical Physics, 17 (2015) 5000-5005.
Y. Lee, Y. Hwang, S. B. Cho, Y.-C. Chung, Achieving a direct band gap in oxygen functionalized-monolayer scandium carbide by applying an electric field, Physical Chemistry Chemical Physics, 16 (2014) 26273-26278.
J. Hu, B. Xu, C. Ouyang, S. A. Yang, Y. Yao, Investigations on V₂C and V₂CX₂ (X═F, OH) monolayer as a promising anode material for Li ion batteries from first-principles calculations, The Journal of Physical Chemistry C, 118 (2014) 24274-24281.
H. Lashgari, M. R. Abolhassani, A. Boochani, S. M. Elahi, J. Khodadadi, Electronic and optical properties of 2D graphene-like compounds titanium carbides and nitrides: DFT calculations, Solid State Communications, 195 (2014) 61-69.
J. Halim, M. R. Lukatskaya, K. M. Cook, J. Lu, C. R. Smith, L.-A. Naslund, S. J. May, L. Hultman, Y. Gogotsi, P. Eklund, M. W. Barsoum, Transparent conductive two-dimensional titanium carbide epitaxial thin films, Chemistry of Materials, 26 (2014) 2374-2381.
L.-Y. Gan, Y.-J. Zhao, D. Huang, U. Schwingenschlogl, First-principles analysis of MoS₂/Ti₂C and MoS₂/Ti₂CY₂ (Y═F and OH) all-2D semiconductor/metal contacts, Physical Review B, 87 (2013) 245307.
L.-Y. Gan, D. Huang, U. Schwingenschlogl, Oxygen adsorption and dissociation during the oxidation of monolayer Ti₂C, Journal of Materials Chemistry A, 1 (2013) 13672-13678.
O. Mashtalir, K. M. Cook, V. N. Mochalin, M. Crowe, M. W. Barsoum, Y. Gogotsi, Dye adsorption and decomposition on two-dimensional titanium carbide in aqueous media, Journal of Materials Chemistry A, 2 (2014) 14334-14338.
X. Wang, S. Kajiyama, H. Iinuma, E. Hosono, S. Oro, I. Moriguchi, M. Okubo, A. Yamada, Pseudocapacitance of MXene nanosheets for high-power sodium-ion hybrid capacitors, Nature Communications, 6:6544 (2015) 1-7.
M. Alhabeb, K. Maleski, B. Anasori, P. Lelyukh, L. Clark, S. Sin, Y. Gogotsi, Guidelines for synthesis and processing of two-dimensional titanium carbide (Ti₃C₂Tₓ MXene), Chemistry of Materials (2017) DOI: 10.1021/acs.chemmater.7b02847.
M. C. Mangarella, K. S. Walton, Tailored Fe₃C-derived carbons with embedded Fe nanoparticles for ammonia adsorption, Carbon, 95 (2015) 208-219.

1. A method of adsorbing an analyte, comprising:
contacting a MXene composition with the analyte, the contacting resulting in selective adsorption of the analyte to the MXene composition.

2. The method of claim 1, wherein the MXene composition is any one of the MXene compositions set forth or referenced herein or made by any of the methods set forth or referenced herein.

3. The method of claim 1, wherein the MXene composition comprises a surface termination that comprises alkoxide, carboxylate, halide, hydroxide, hydride, oxide, sub-oxide, nitride, sub-nitride, sulfide, thiol, or a combination thereof.

4. The method of claim 1, wherein the MXene composition is characterized as being in the form of a suspension, a powder, a gel, a film, a fabric, a composite, a fiber, or any combination thereof.

5. The method of claim 1, wherein the analyte is characterized as a toxic industrial chemical, a nerve agent, a simulant, an opioid, a narcotic, a cholinesterase inhibitor, a blood agent, or any combination thereof.

6. The method of claim 1, wherein the MXene composition is configured so as to preferentially reject at least one of water and a hydrocarbon.

7. The method of claim 1, further comprising effecting conditions so as to release at least some of the analyte adsorbed to the MXene composition.

8. A selective adsorption system, comprising:
a MXene composition,
the MXene composition being configured for placement into fluid communication with an analyte.

9. The selective adsorption system of claim 8, wherein the MXene composition is characterized as being in the form of a suspension, a powder, a gel, a film, a fabric, a composite, a fiber, or any combination thereof.

10. The selective adsorption system of claim 8, wherein the MXene composition comprises a surface termination that comprises alkoxide, carboxylate, halide, hydroxide, hydride, oxide, sub-oxide, nitride, sub-nitride, sulfide, thiol, or a combination thereof.

11. The selective adsorption system of claim 8, wherein the MXene composition is in communication with a sensor configured to detect the presence of the analyte adsorbed to the MXene composition.

12. An analyte storage system, comprising a MXene composition configured to selectively adsorb a first analyte, the first analyte optionally comprising a gas.

13. The analyte storage system of claim 12, the system configured to effect release of first analyte adsorbed to the MXene composition.

14. The analyte storage system of claim 12, the system being configured to support a chemical reaction on first analyte adsorbed to the MXene composition.

15. A method, comprising: contacting at least one MXene composition to a medium suspected of containing an analyte, the contacting being performed under conditions sufficient to support adsorption of the analyte to the at least one MXene composition; exposing the at least one MXene composition to conditions sufficient to release adsorbed analyte, if present, from the at least one MXene composition into a release medium; and detecting the presence of released analyte in the release medium.

16. The method of claim 15, wherein the at least one MXene composition is configured to selectively adsorb a first analyte and a second analyte from the medium.

17. The method of claim 16, wherein the at least one MXene composition is exposed to conditions sufficient to release the first analyte from the MXene composition and to release the second analyte from the MXene composition.

18. The method of claim 17, wherein the conditions sufficient to release the first analyte from the MXene composition differ from the conditions sufficient to release the second analyte from the MXene composition.

19. The method of claim 15, wherein the method is performed in a manual fashion.

20. The method of claim 15, wherein the method is performed in an automated fashion.
